(19) United States
(12) Patent Application Publication
(10) Pub. No.: US 2005/0289622 A1
(43) Pub. Date: Dec. 29, 2005

(54) Method for providing interactive television programming

(76) Inventors: Marc Vanlerberghe, Sunnyvale, CA (US); Alan Toman, Hollywood, CA (US); Rick Davis, Valley Village, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/129,609

(22) Filed: May 13, 2005

Related U.S. Application Data
(60) Provisional application No. 60/571,413, filed on May 14, 2004.

(51) Int. Cl. H04N 7/16; H04N 7/18

(52) U.S. Cl. 725/100; 725/62; 725/81

(57) ABSTRACT

A method for creating original, interactive television programming is described. In one embodiment, a Short Messaging System (SMS) gateway is used to route text messages from a user's wireless device through a wireless carrier to a server, and from that server, the SMS data is converted to a graphical format, which can be added to a broadcast television signal.

### REFERENCES CITED

This utility patent application incorporates by reference the following attached U.S. provisional application, 60/571,413, filed May, 14, 2004.

### SUMMARY OF THE INVENTION

This document describes an invention relating to a method for creating original, interactive television programming using a Short Messaging System (SMS) gateway to route text messages from a user's wireless device through a wireless carrier to a server, and from that server, converting the SMS data to a graphical format, which can be added to a broadcast television signal.

As increasing numbers of people are embracing the text messaging capabilities of their cellular telephones, and more and more television watchers are tuning in to reality television shows such as “American Idol,” where the audience can vote for the winners, the ability of broadcast television programs to provide truly live, interactive television is in high demand by viewers and advertisers alike. This invention focuses on creating live, interactive television programming, which the audience members can participate in via their text-enabled wireless devices.

This invention combines an SMS gateway used to route SMS messages through a wireless carrier, to internal servers, with the use of software that aggregates and converts the SMS data to a graphical program that can be added to broadcast television signals, and applies the combination to a television show, creating an interactive show with live audience participation.

### BRIEF DESCRIPTION OF THE DRAWINGS

FIGS. 1A-1L are illustrations of one embodiment of an SMS gateway and router that can be used to implement a preferred embodiment of the invention.

FIGS. 2A-2P are illustrations of the exemplary displays and block diagrams of the architecture of one embodiment of the software used to convert the SMS data to a graphic format to be added to a television broadcast signal in a preferred embodiment of the invention.

FIGS. 3A-3G are exemplary displays of one of the preferred embodiment of the invention.

### DETAILED DESCRIPTION OF THE DRAWINGS

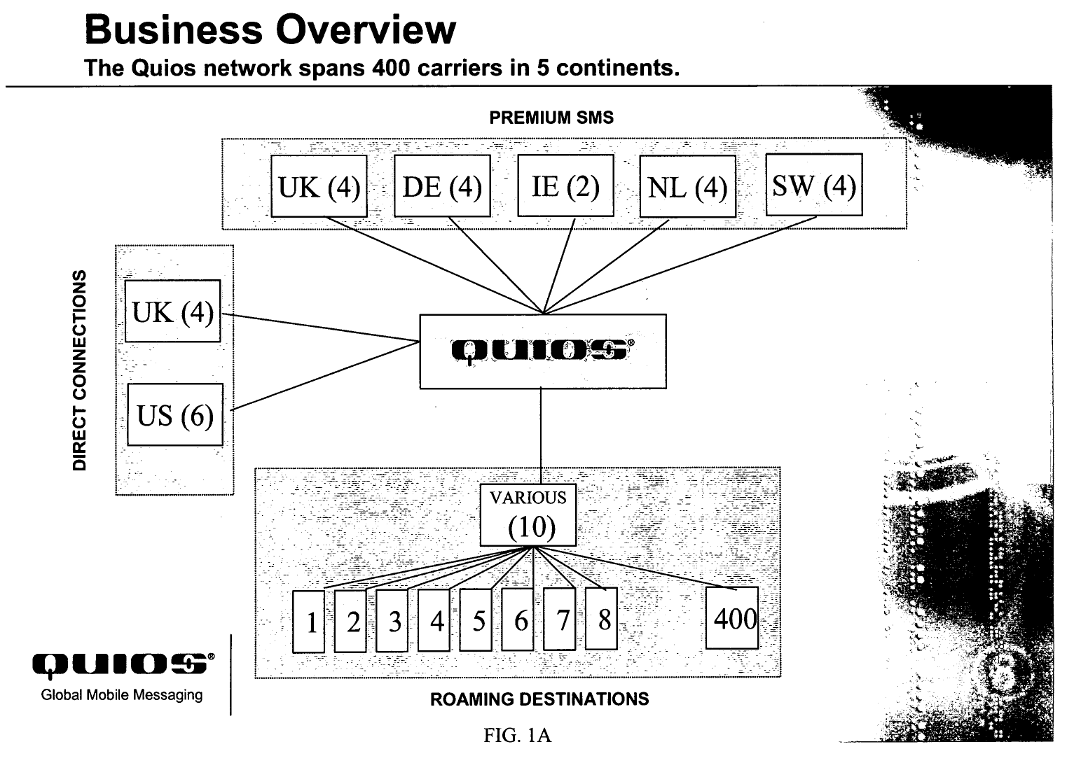

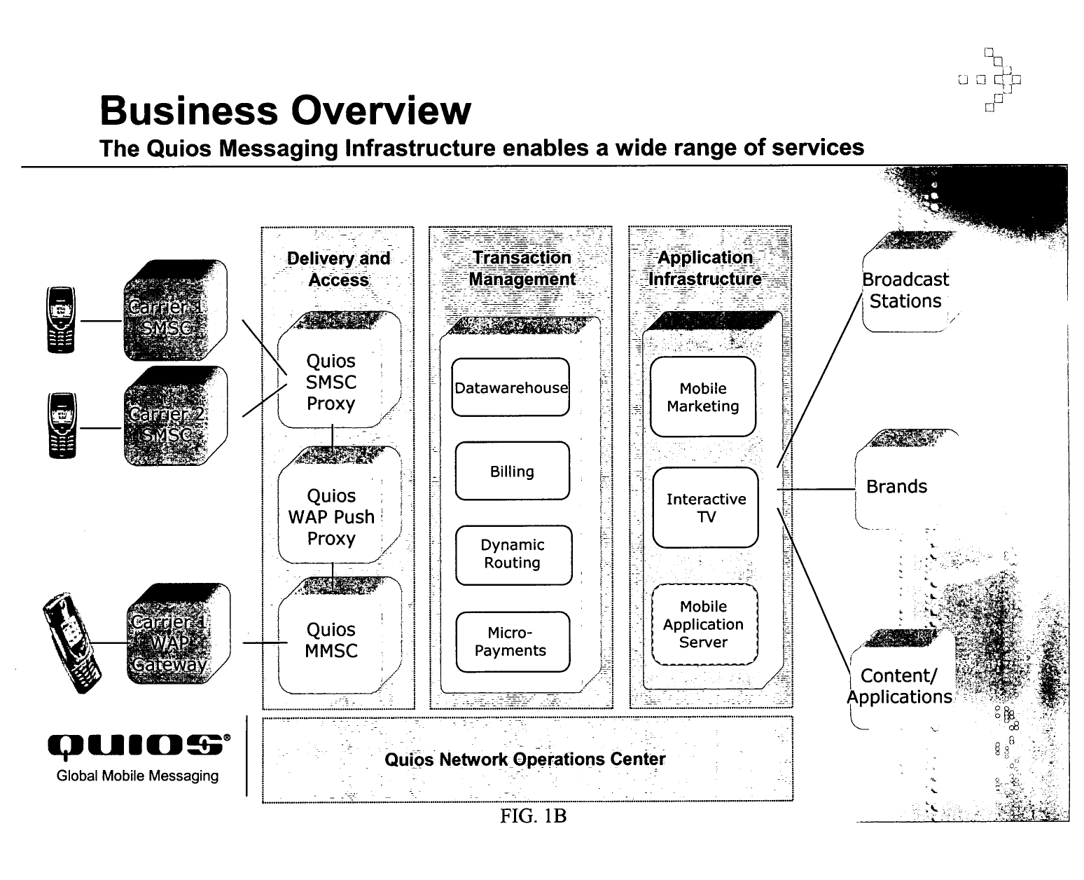

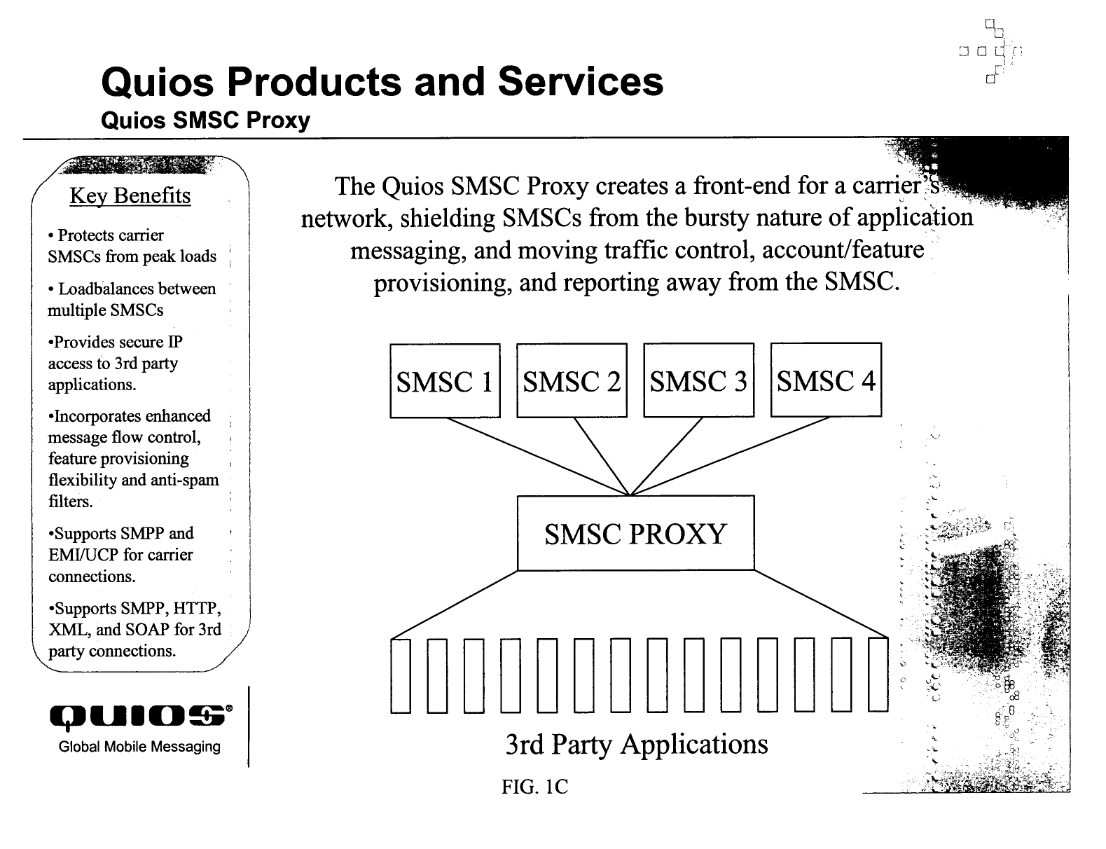

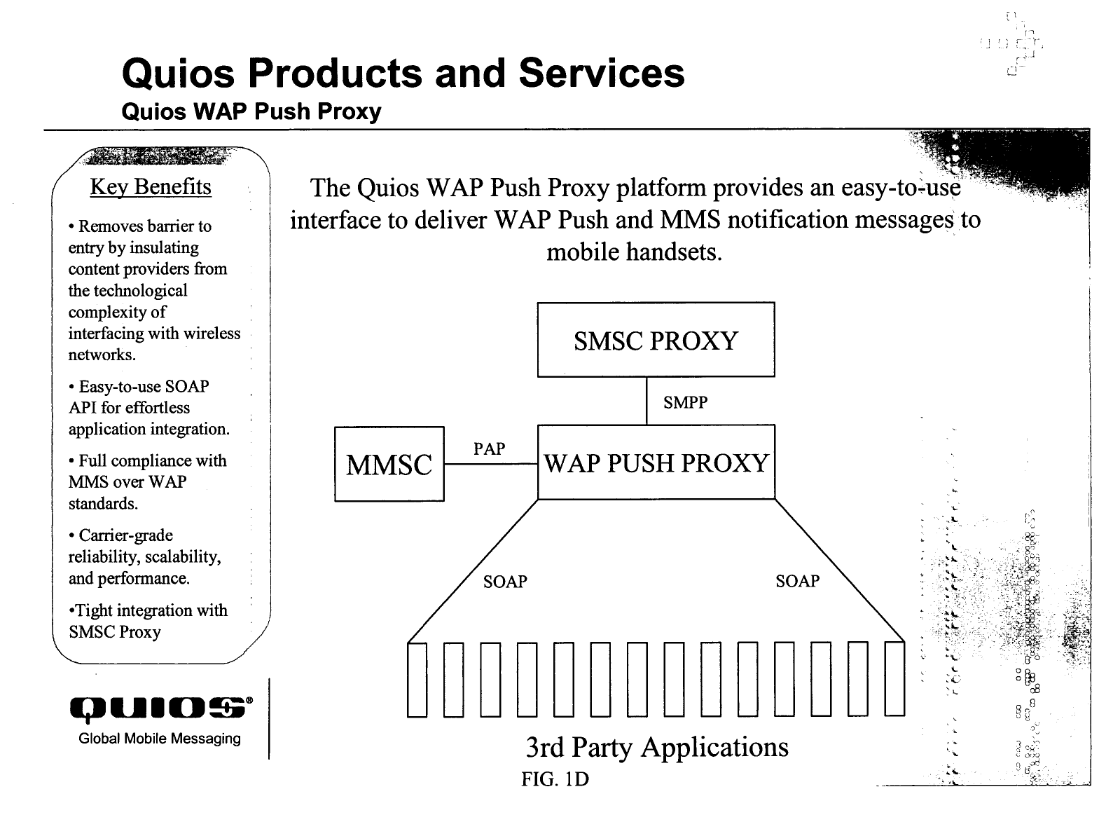

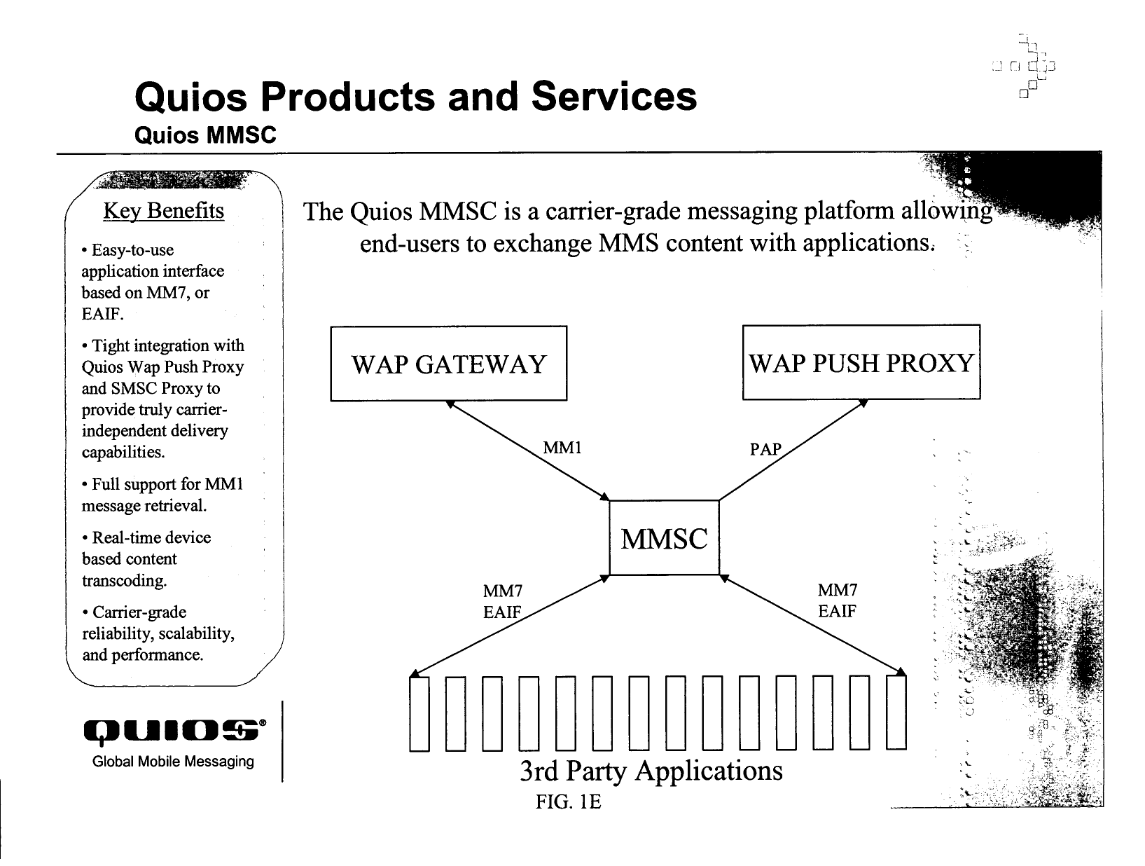

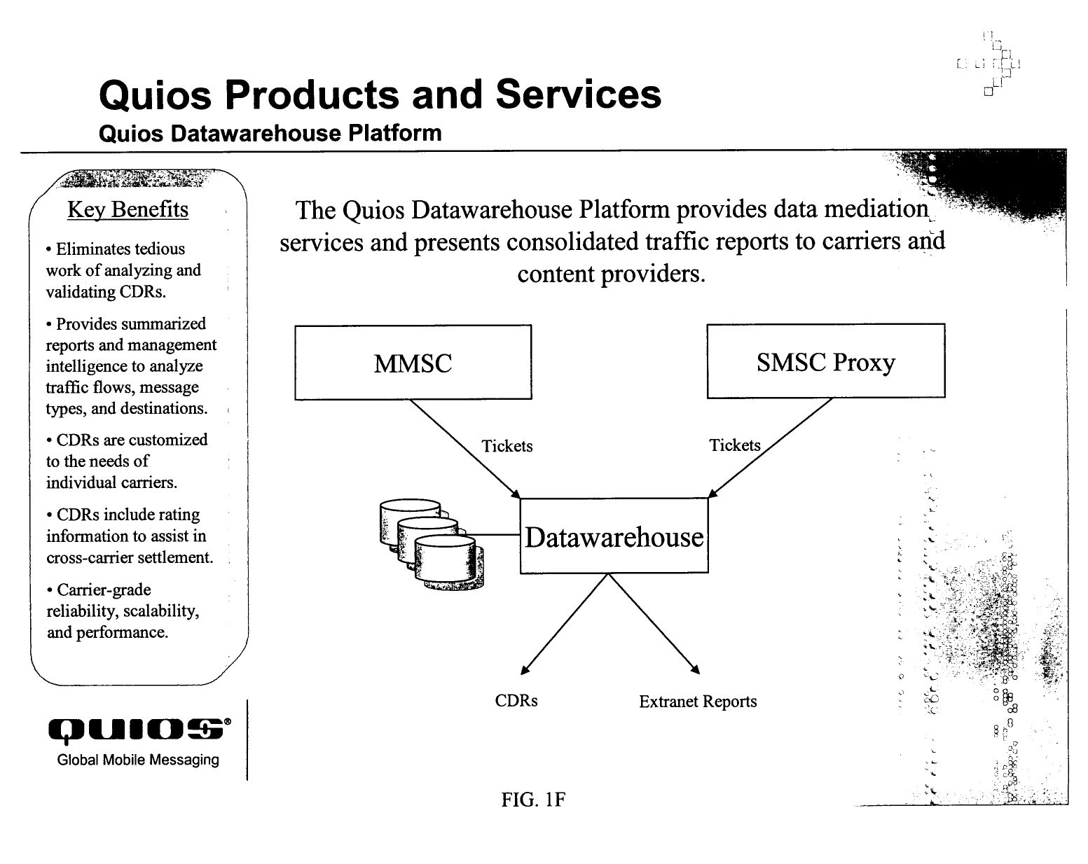

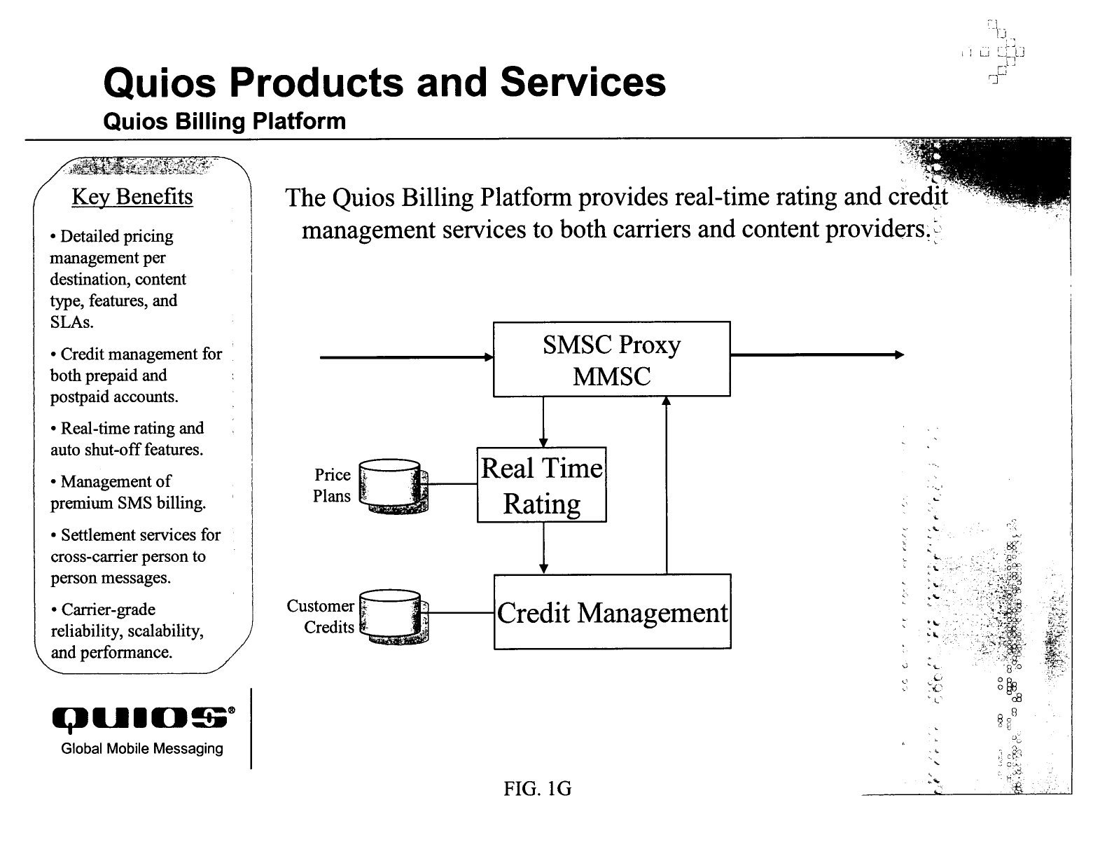

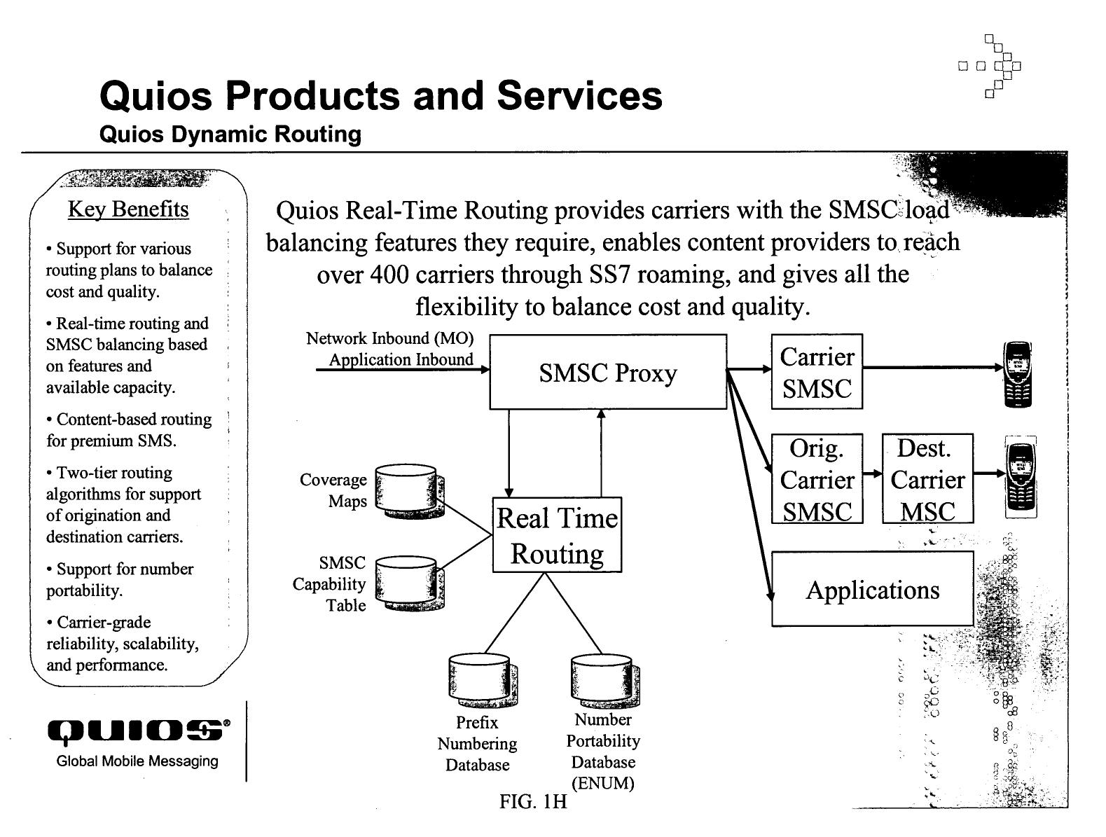

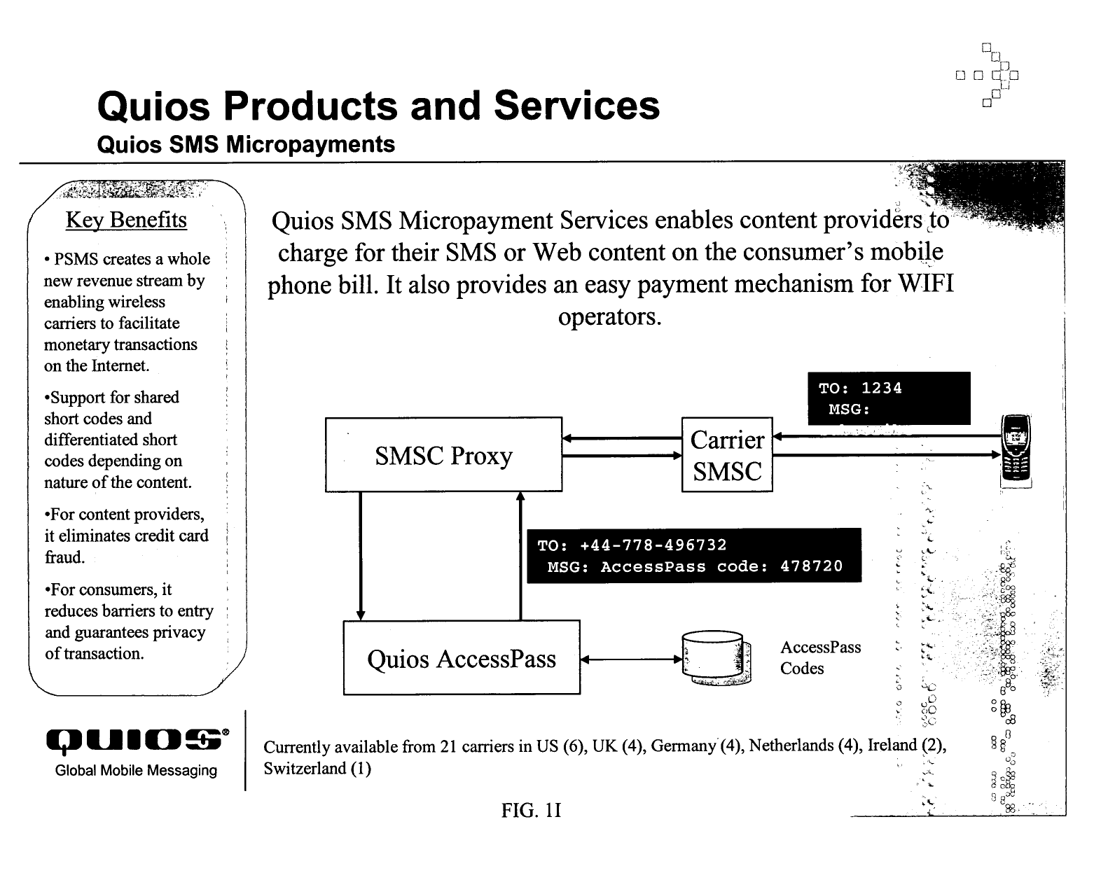

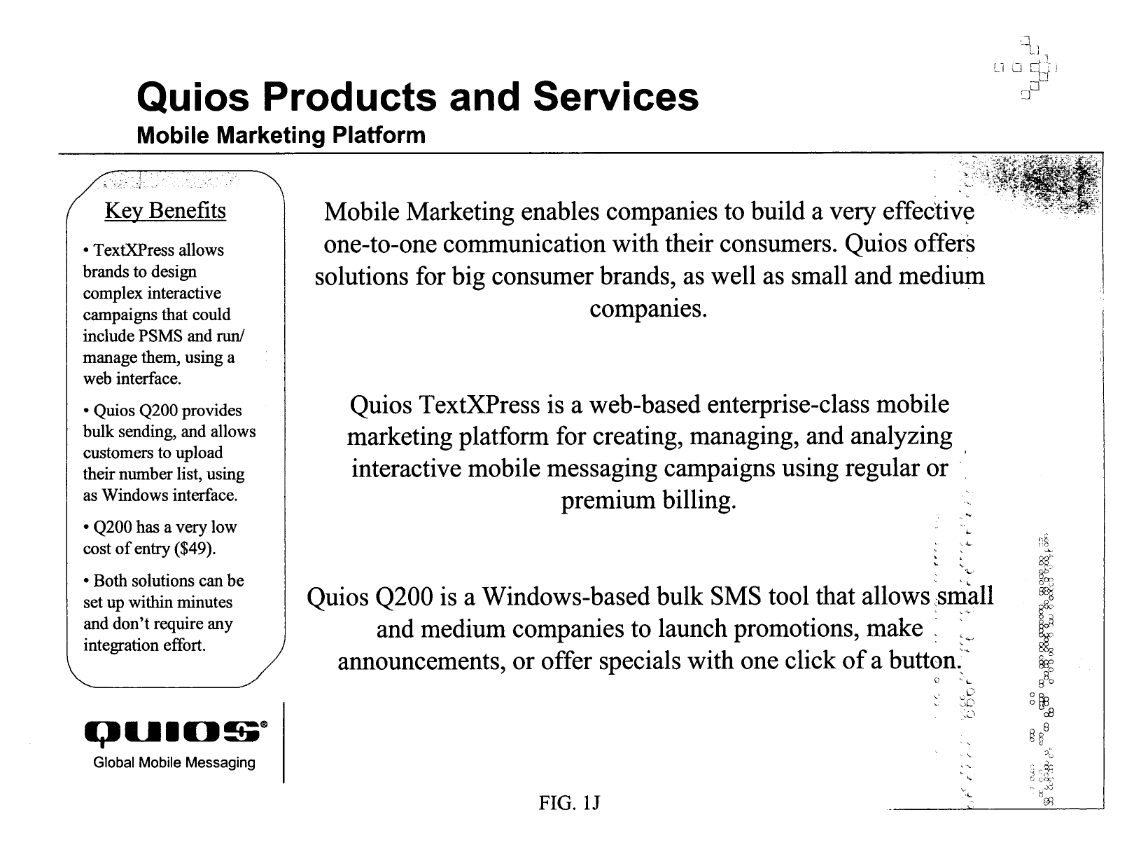

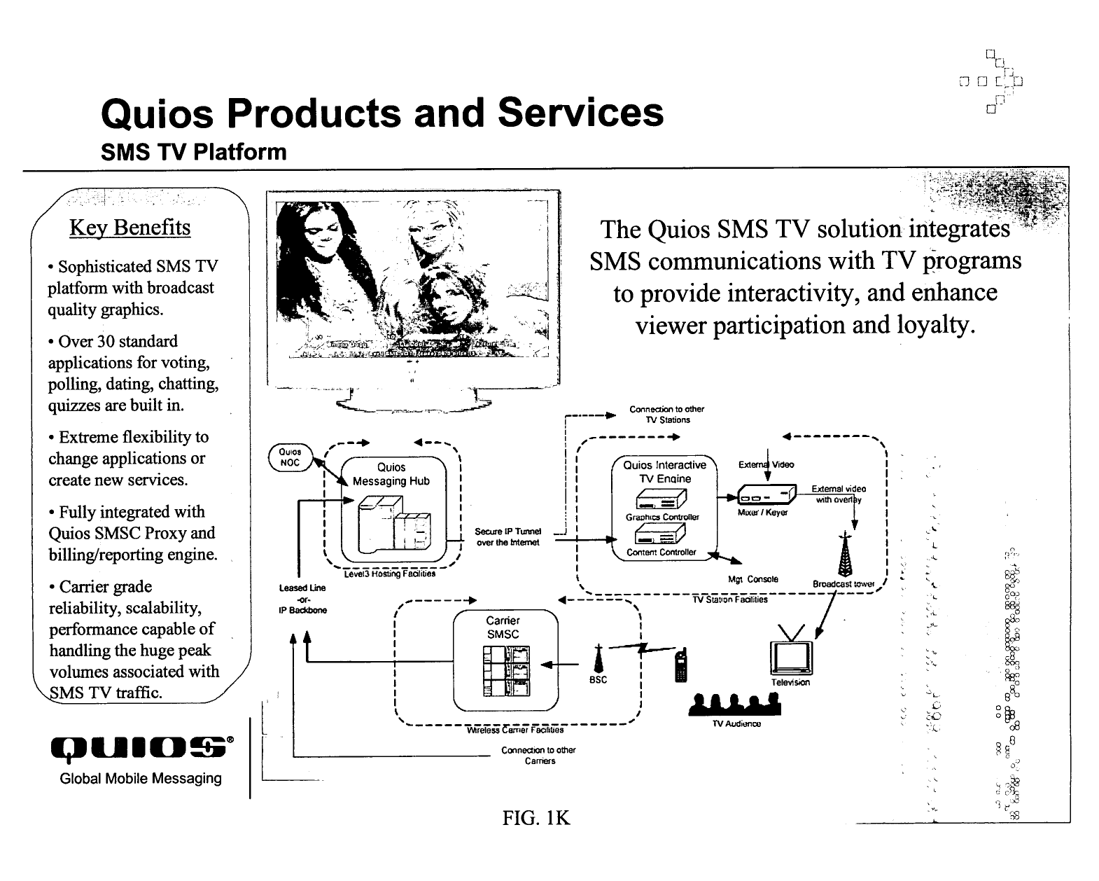

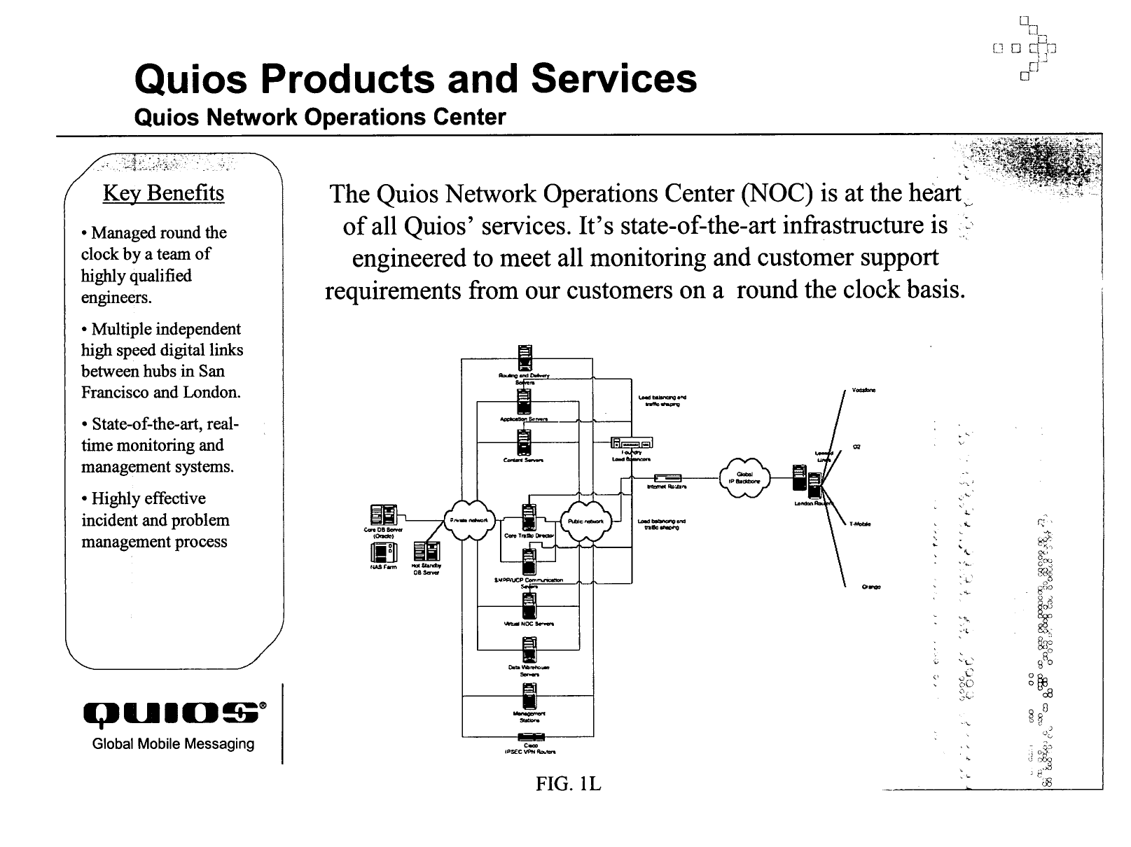

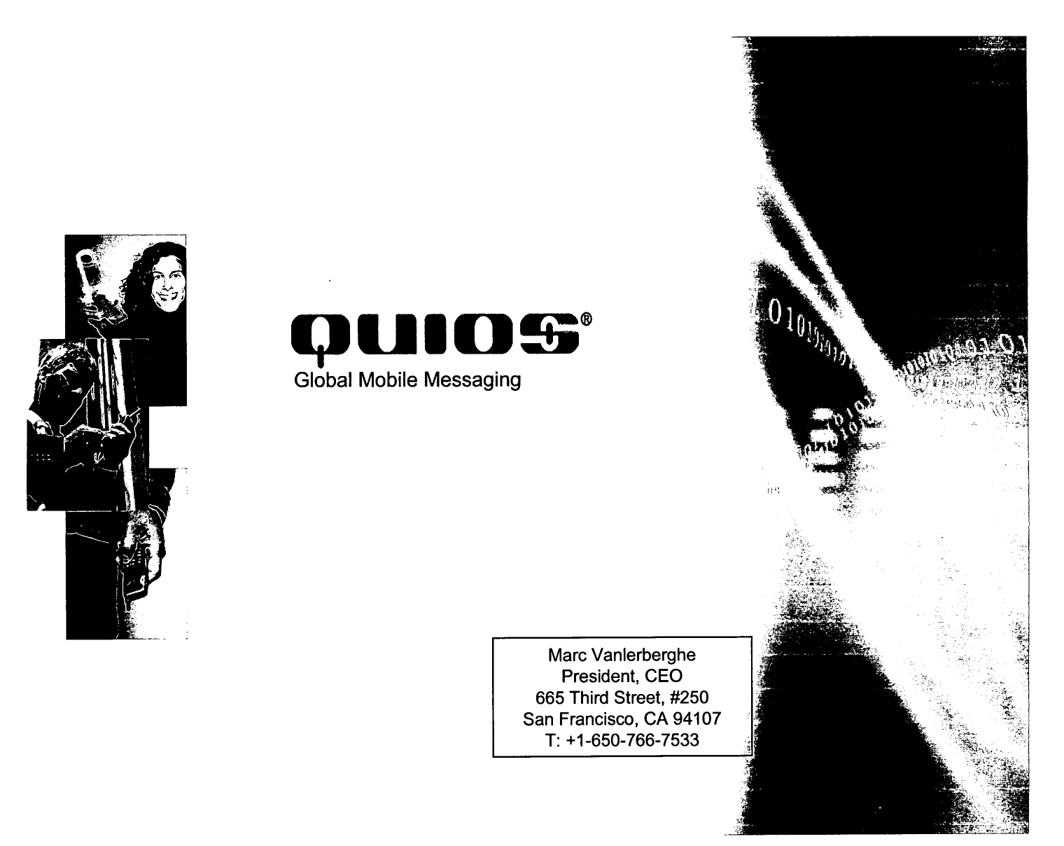

FIGS. 1A-1L are illustrations of one embodiment of an SMS gateway and router that can be used to implement a preferred embodiment of the invention. One embodiment of an SMS gateway and router that can be used to implement a preferred embodiment of the invention is the Quios cross-carrier messaging gateway. (See FIGS. 1A-1L and Quios Global Mobile Messaging: Corporate Overview Initiative Media, incorporated by reference in provisional application 60/571,413.) SMS is a feature that allows users to receive or transmit short text messages using a wireless phone. Using SMS, an alpha numeric message can be transmitted to and from a mobile phone, which then displays the message. The SMS gateway utilized in this invention enables one to route SMS messages from any text-enabled wireless device, through any wireless carrier in the U.S. and on 400 networks worldwide, to internal servers.

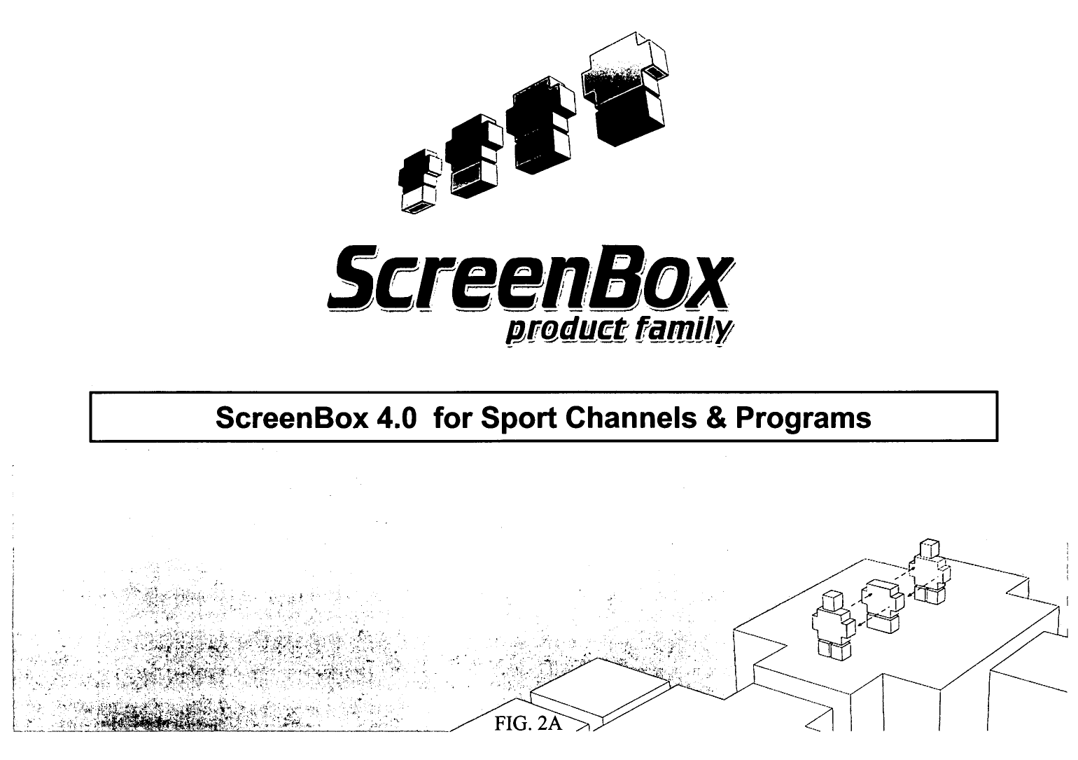

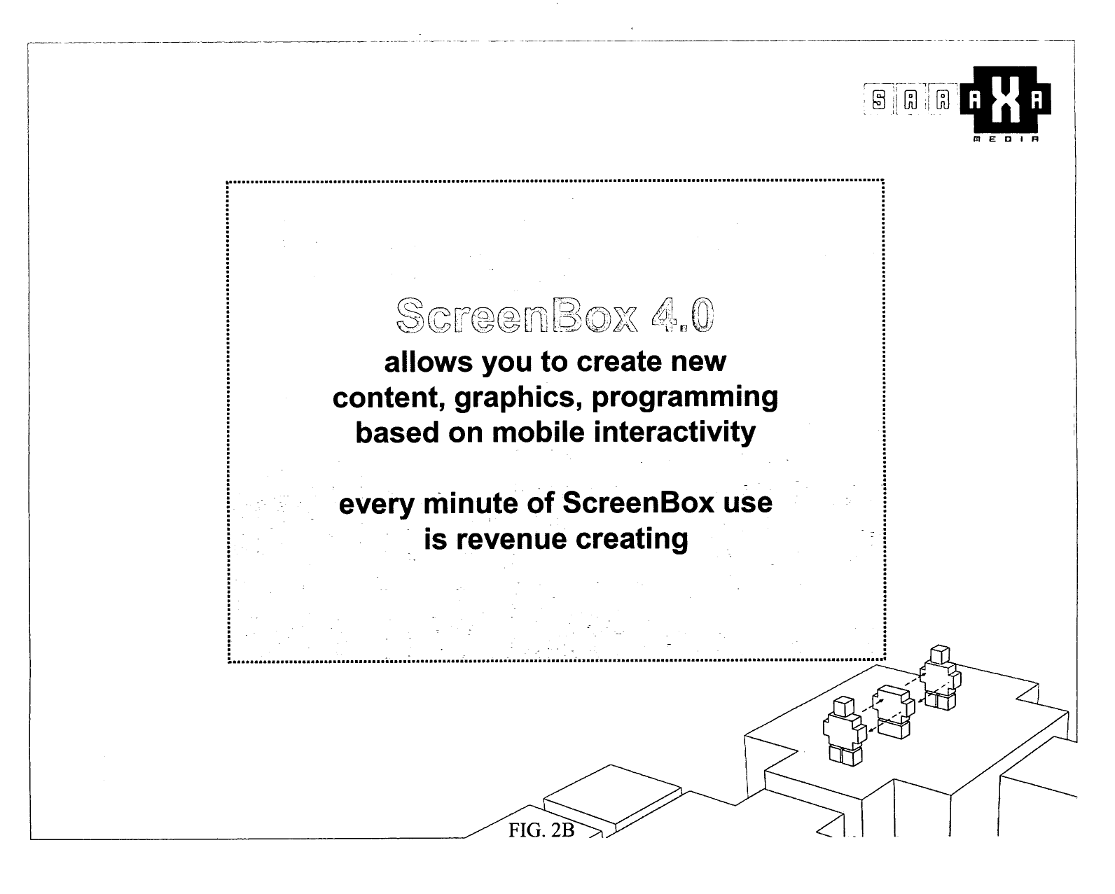

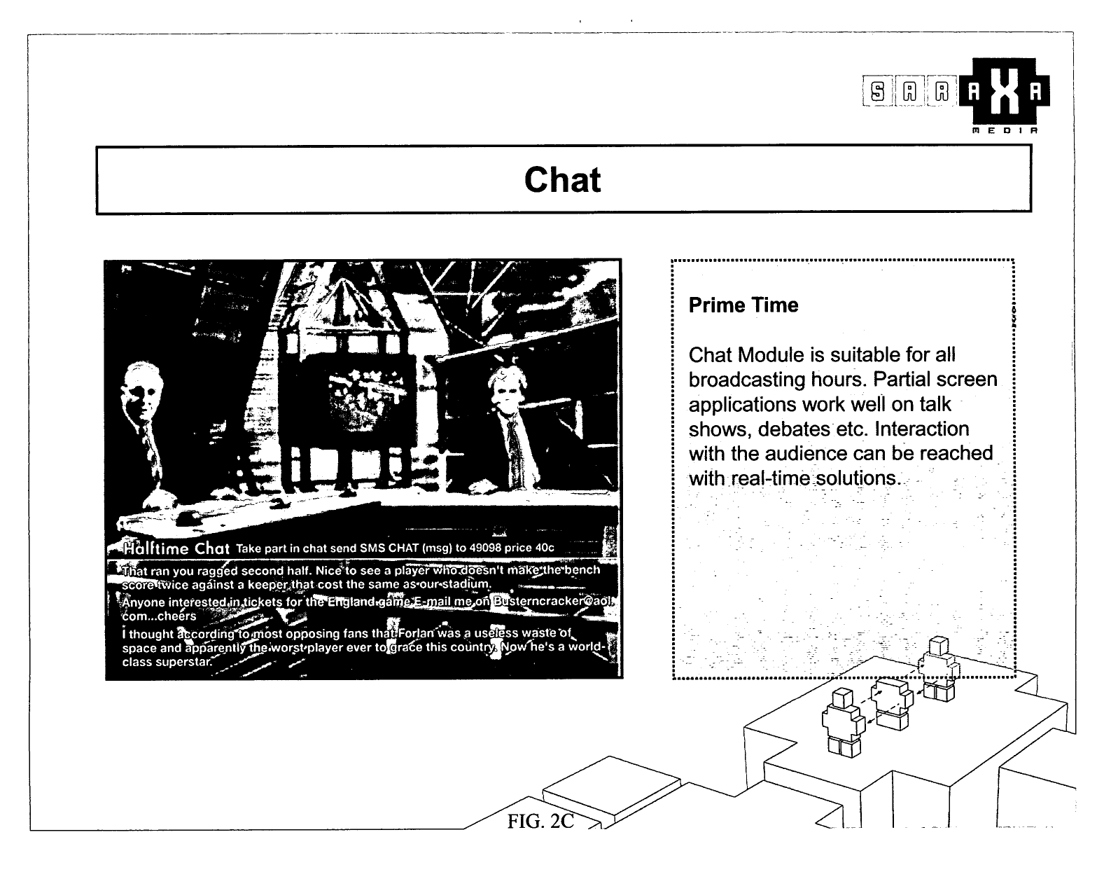

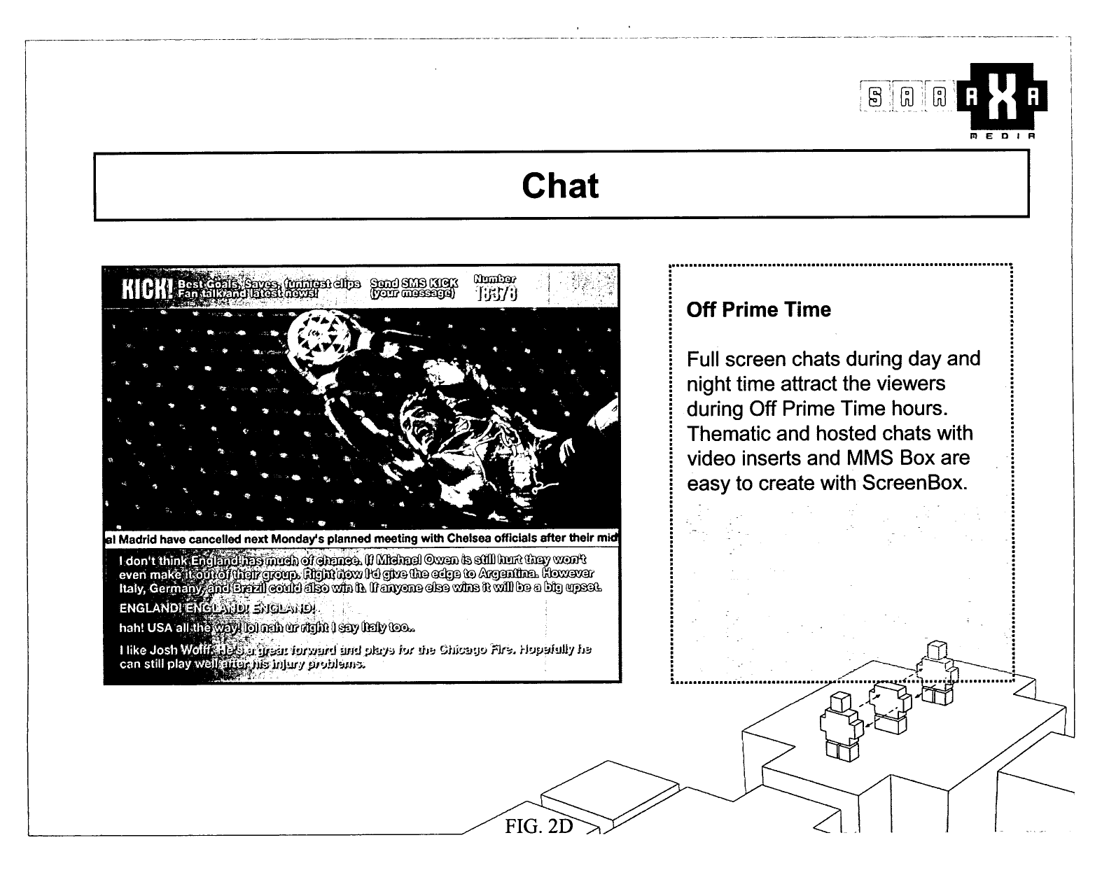

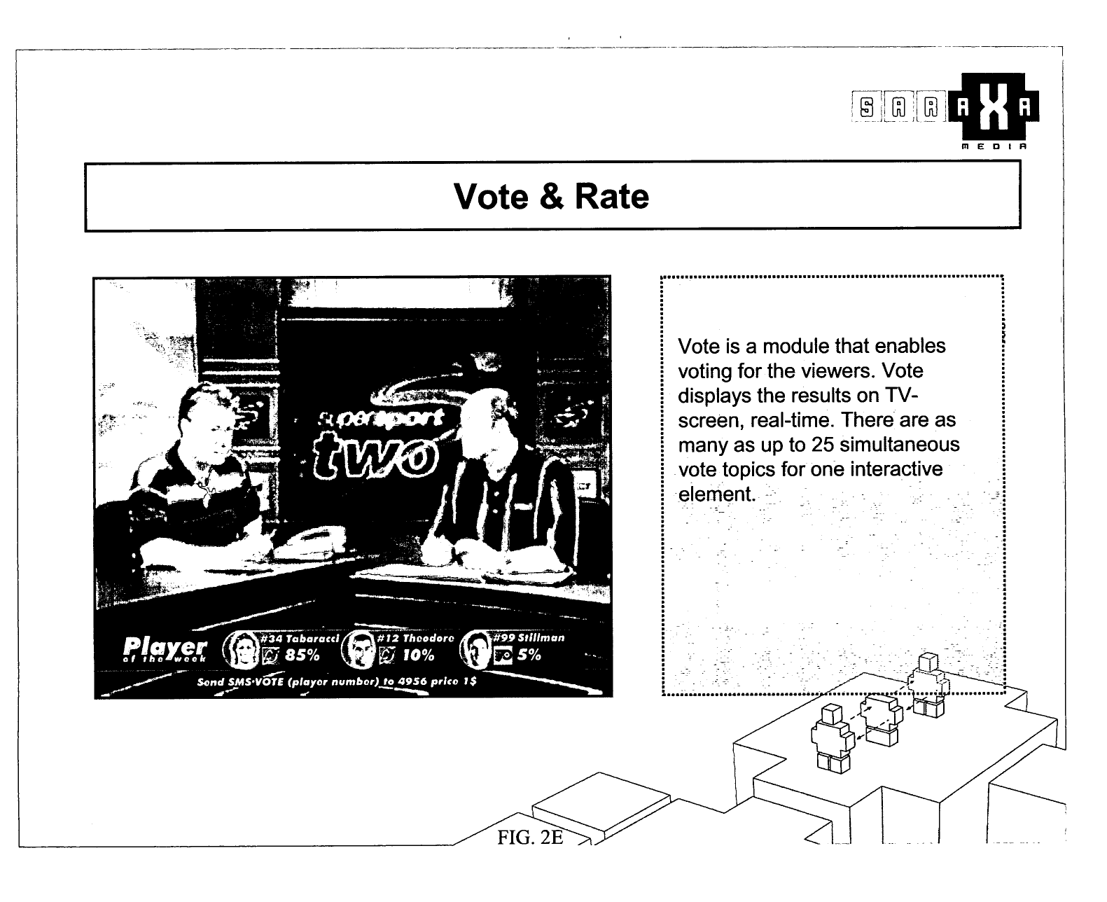

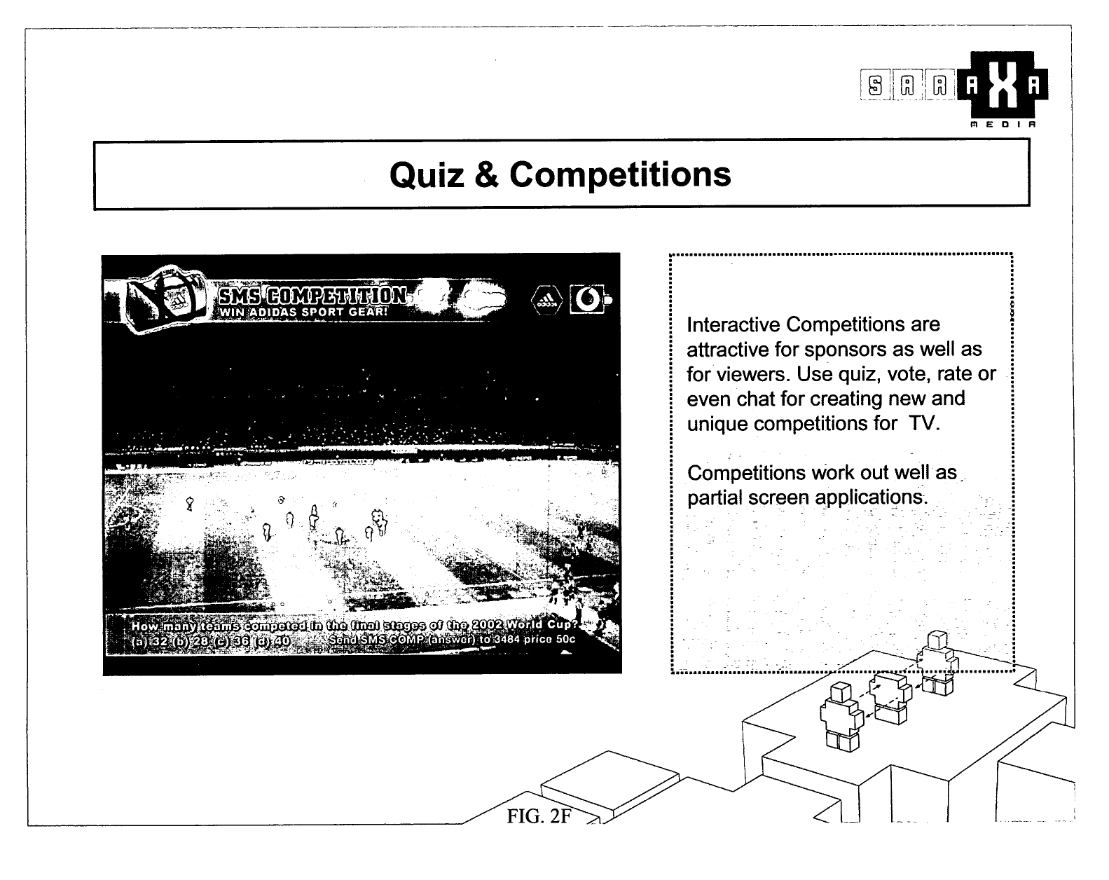

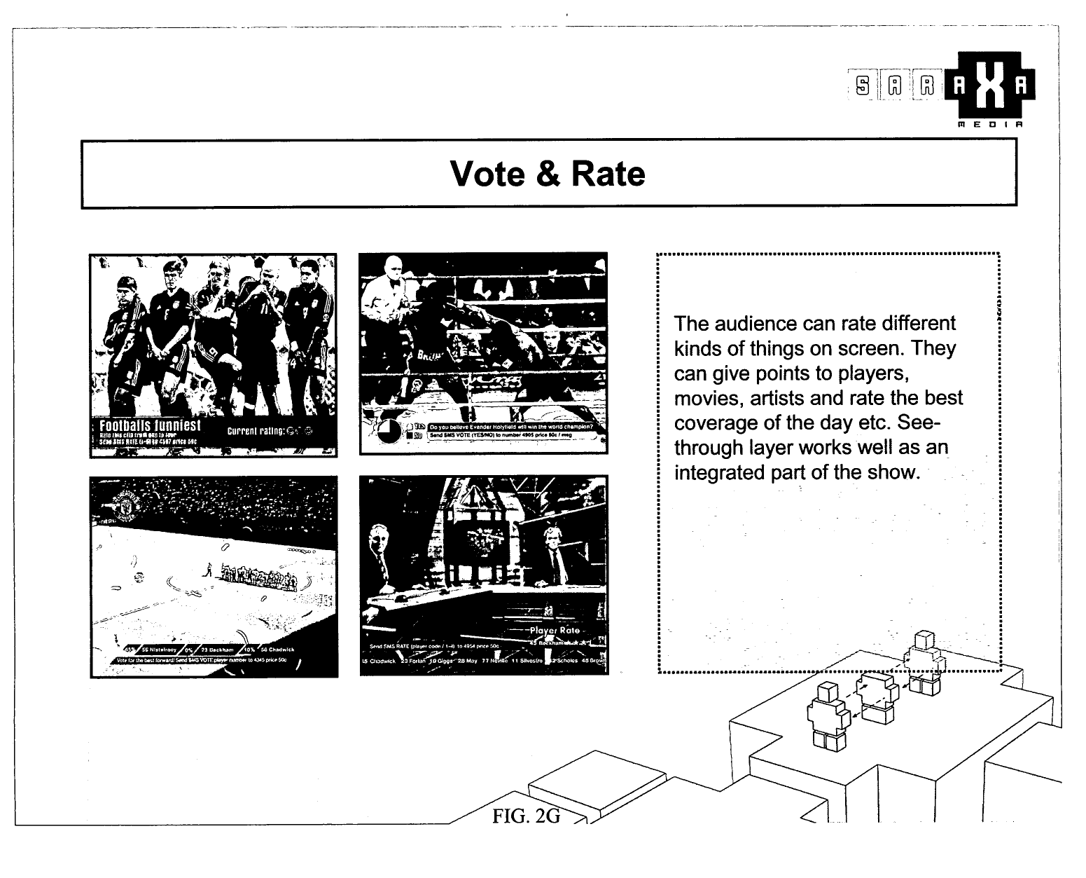

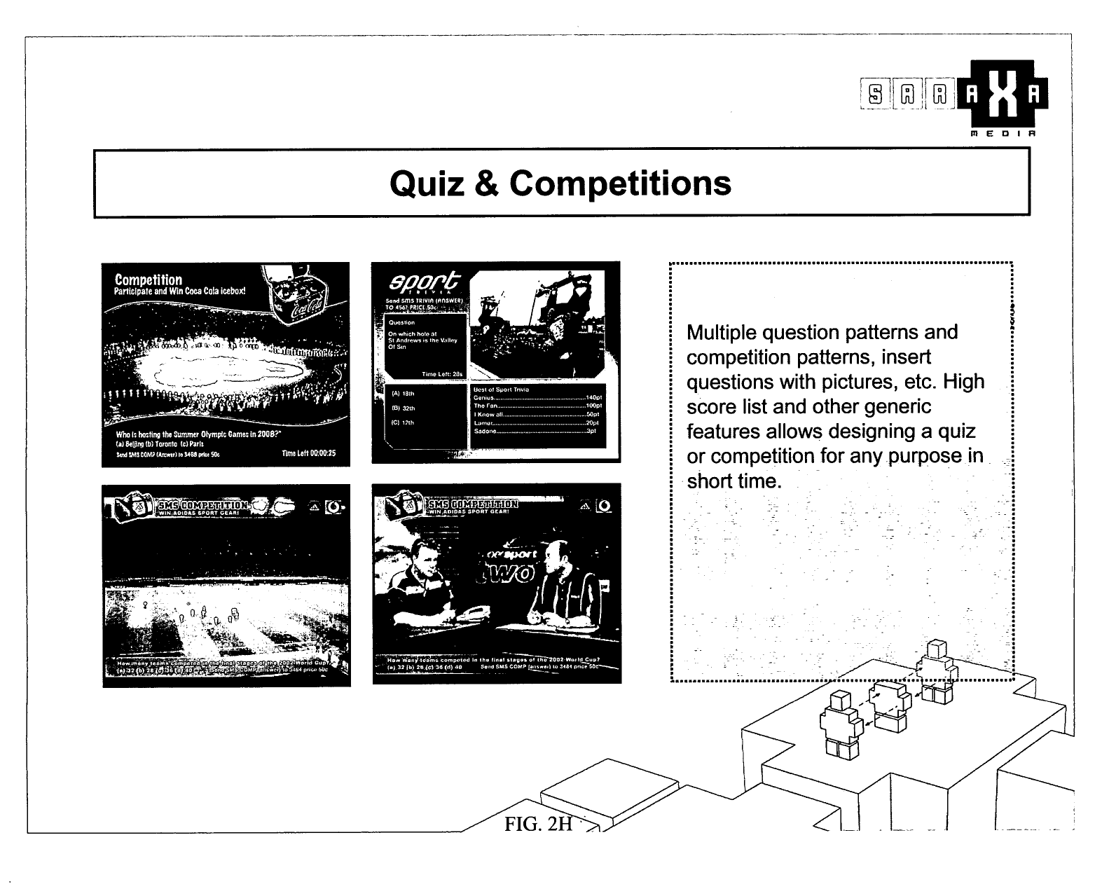

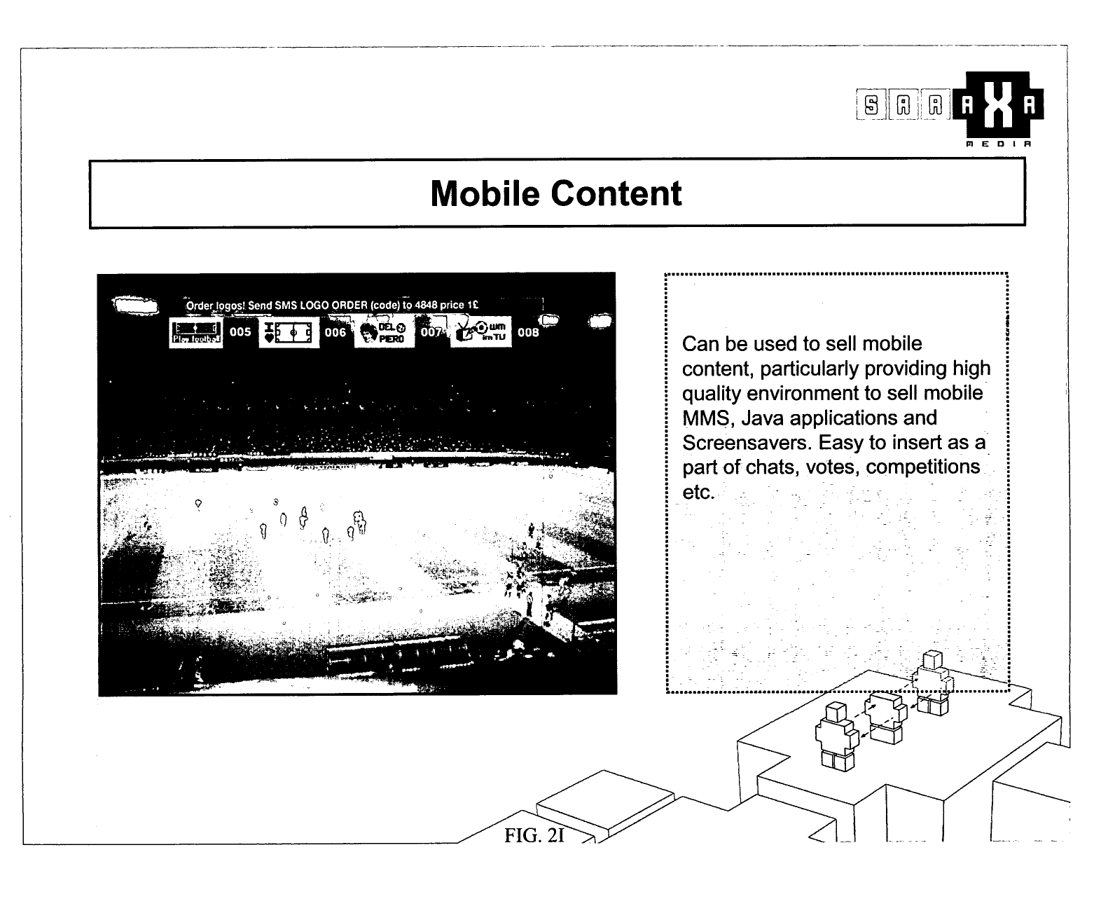

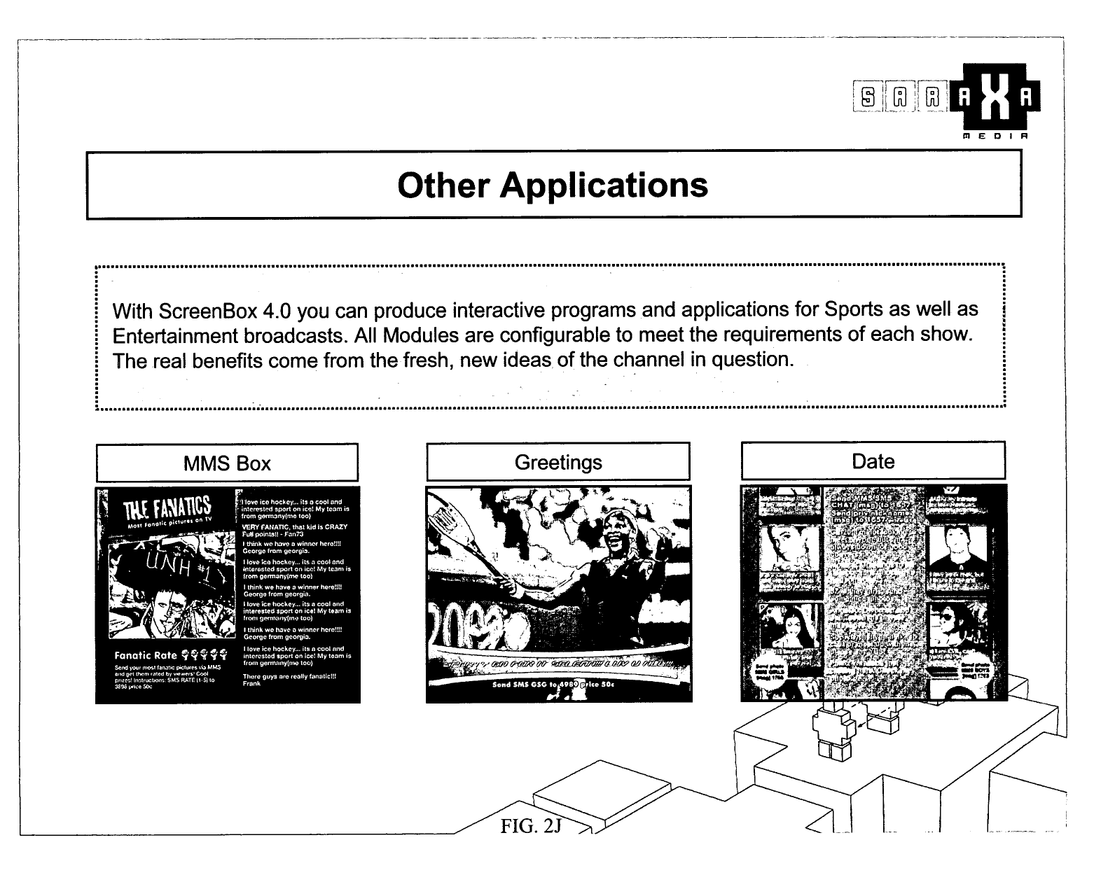

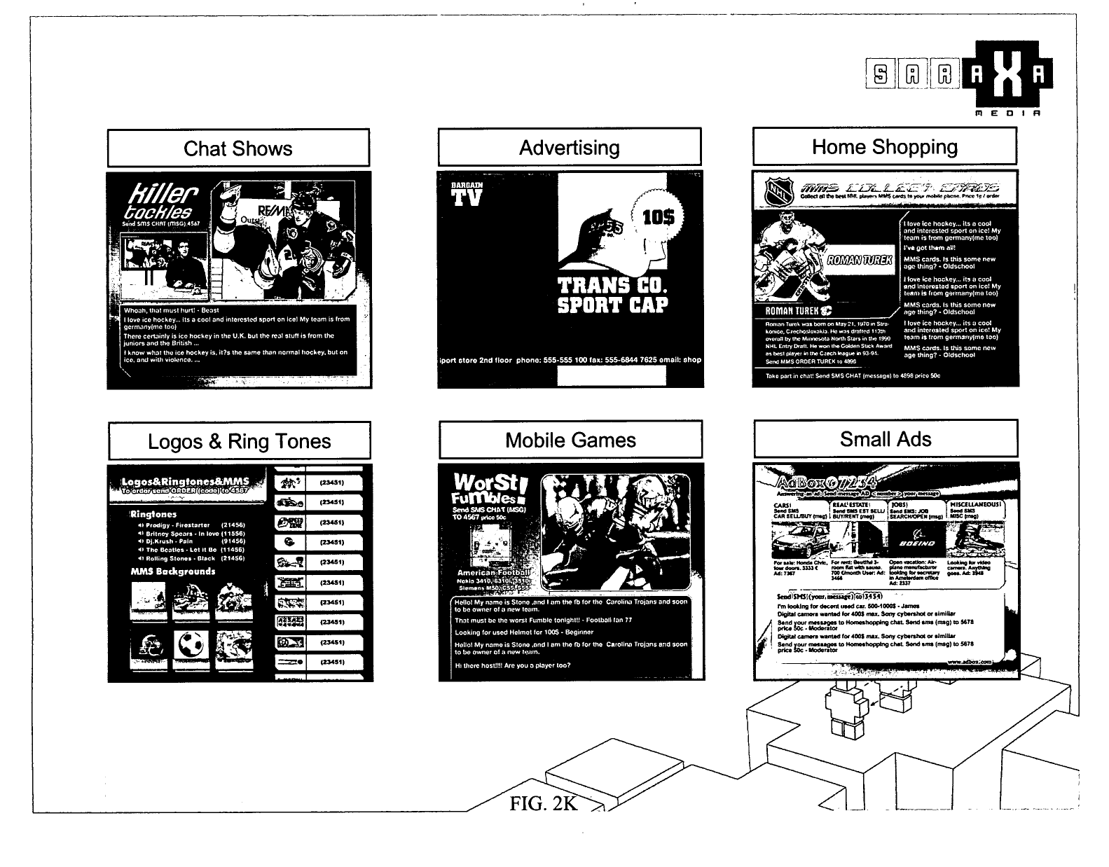

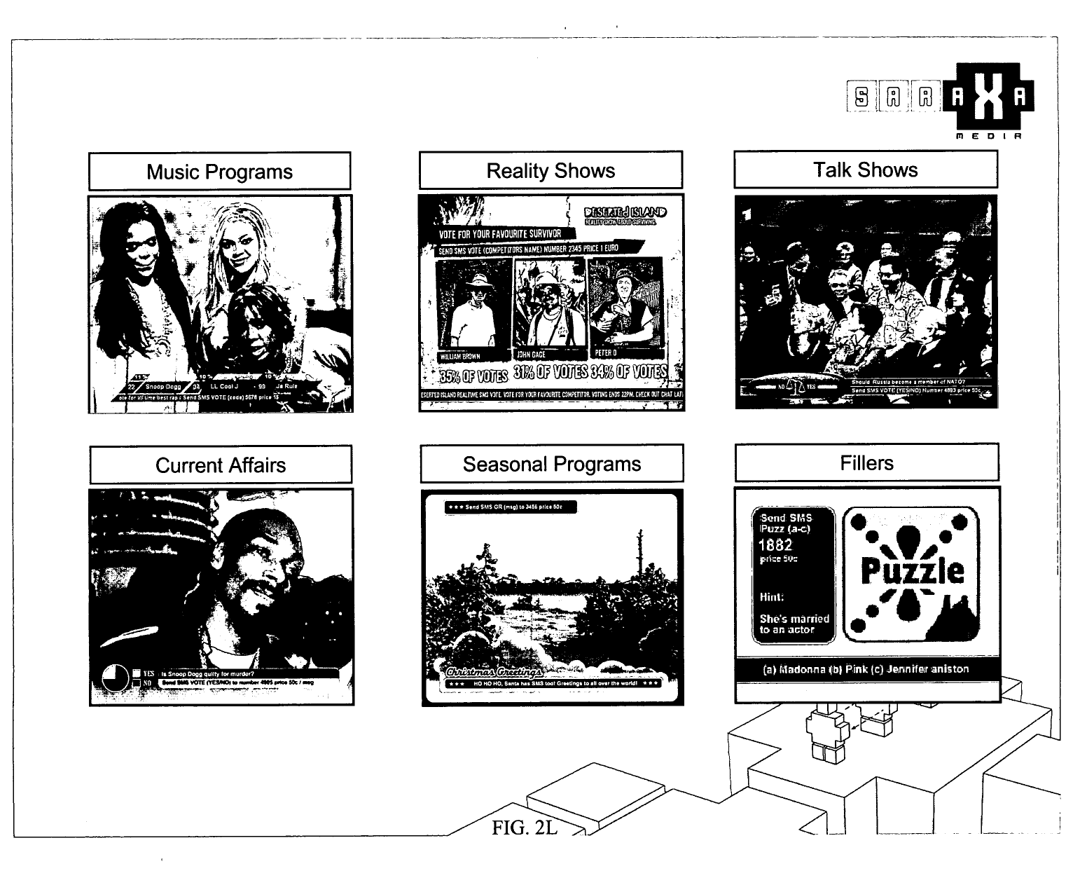

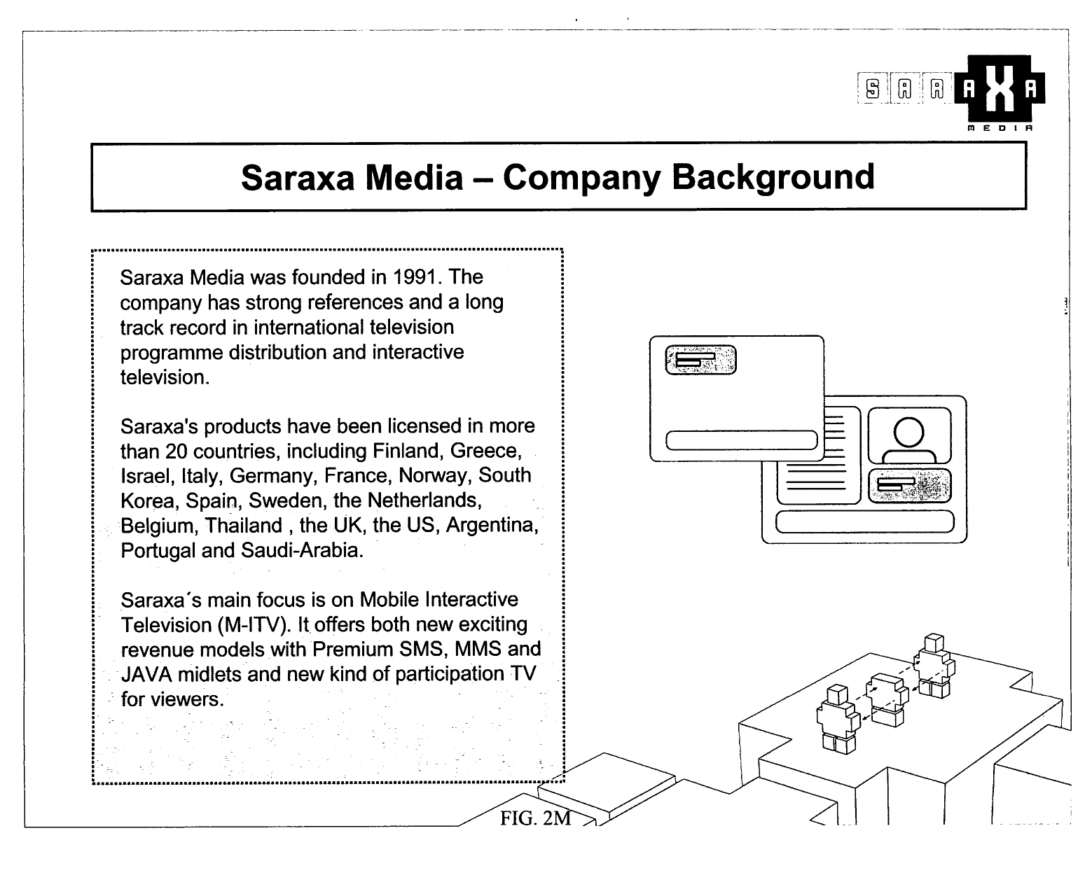

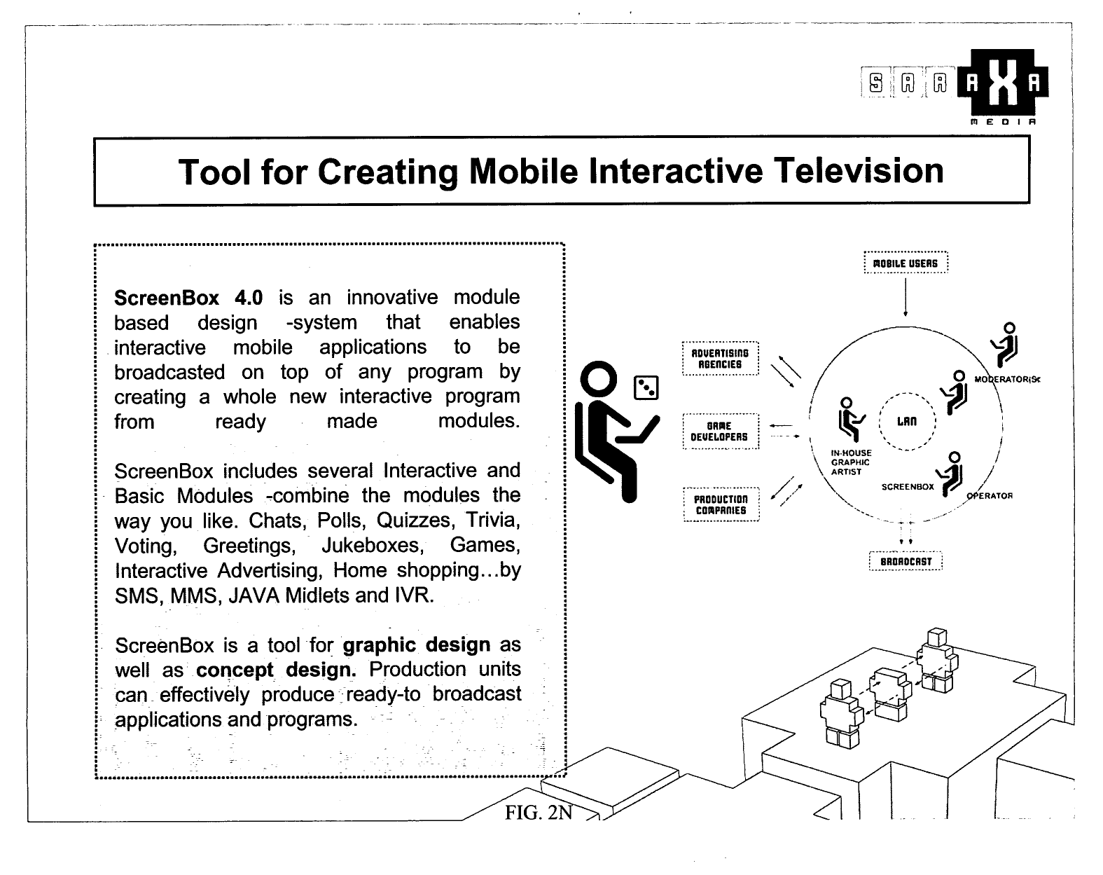

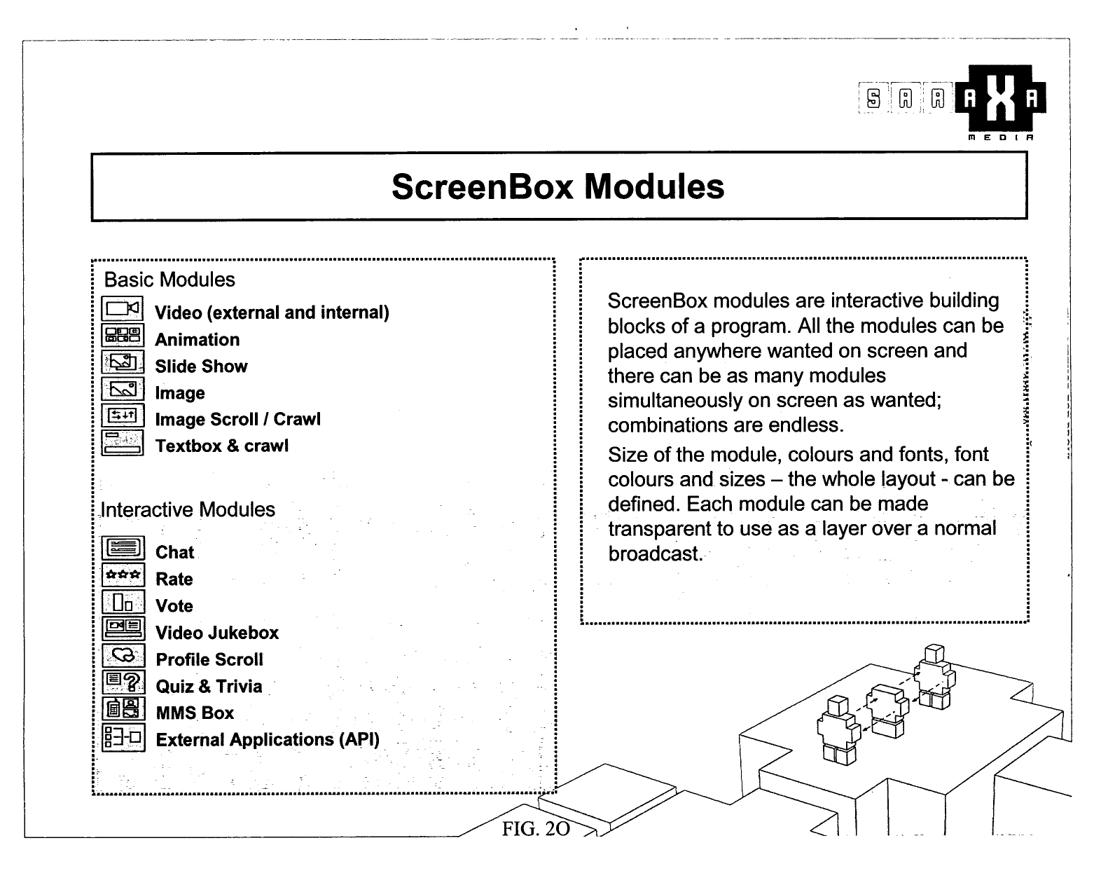

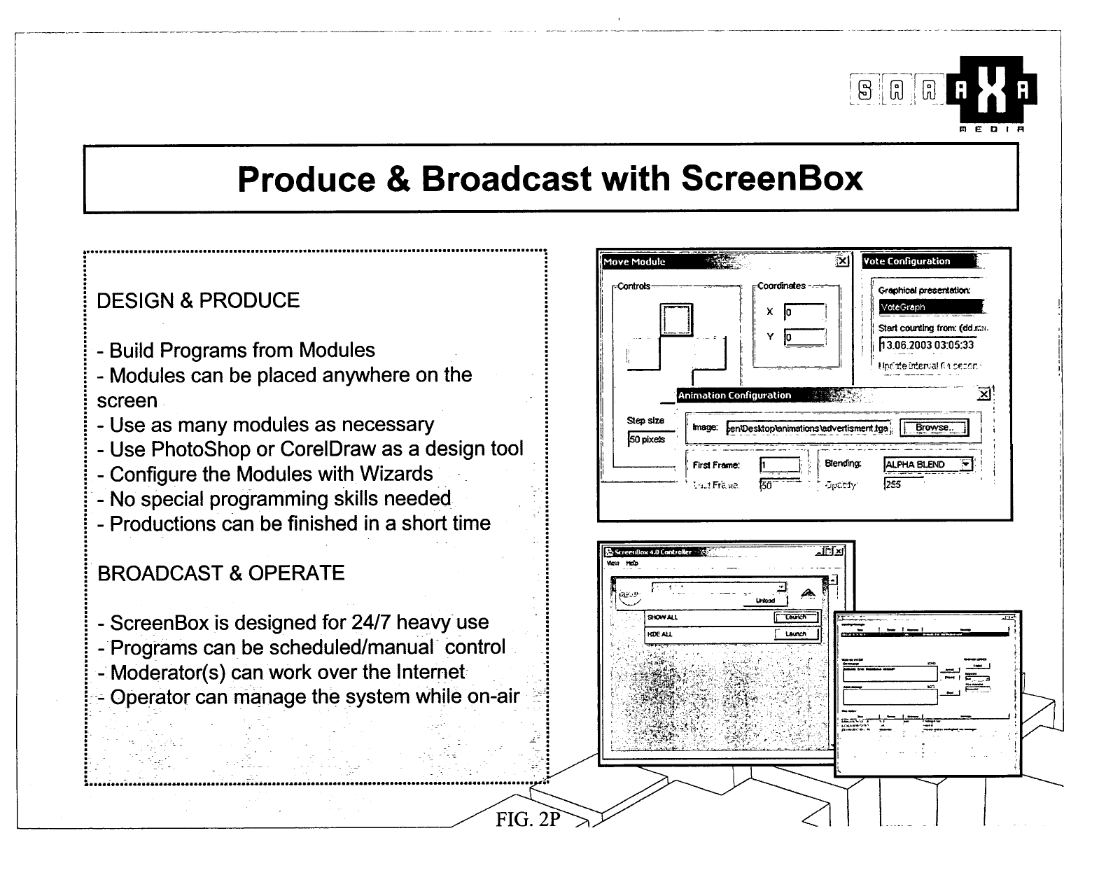

FIGS. 2A-2P are illustrations of the exemplary displays and block diagrams of the architecture of one embodiment of the software used to convert the SMS data to a graphic format to be added to a television broadcast signal in a preferred embodiment of the invention. One embodiment of the software used to convert the SMS data to a graphic format to be added to a television broadcast signal that can be used to implement a preferred embodiment of the invention is the ScreenBox 4.0 made by Saraxa. (See FIGS. 2A-2P and ScreenBox 4.0 for Sports Channels & Programs, incorporated by reference in provisional application 60/571,413.) The ScreenBox software aggregates SMS data from individuals sending text messages and converts it to a graphical program. The SMS text data in graphical format can then be added to a broadcast television signal in the control room.

The inventors have combined the technology of routing SMS data from individual text messages through a wireless carrier to an internal server, with software capable of collecting such data and converting it to a graphical format, which can be added to a broadcast television signal, and applying it to television programming concepts to create live, interactive television programs.

Although SMS routing capability exists to capture SMS data from individuals sending text messages via any carrier in the U.S. or 400 networks worldwide, the practical application of the technology to create truly interactive television programming has not been made. Likewise, the ScreenBox software is currently available to collect SMS data routed to a server and covert it to a graphical format that can be added to broadcast television signals from the control room. Nonetheless, the ScreenBox technology has not been applied to innovative and exciting television programming concepts, which include the layout and use of the graphical SMS information on the screen and within the content of the television program itself.

The combination of SMS routing technology with ScreenBox software can be applied to television programming concepts, screen formatting and layout, and audience participation written into the program itself, to create truly live, interactive television.

A preferred embodiment of the invention provides a method for creating truly interactive television programming, with the ability of the audience to participate in a live program as it progresses to affect the outcome of each episode. The key benefit of the proposed method is that millions of potential television viewers are implementing the text messaging capabilities of their cellular phones as a method of both communication and entertainment. This invention combines the SMS technology with television programming to enable viewers to participate in live television shows by using text-enabled wireless devices.

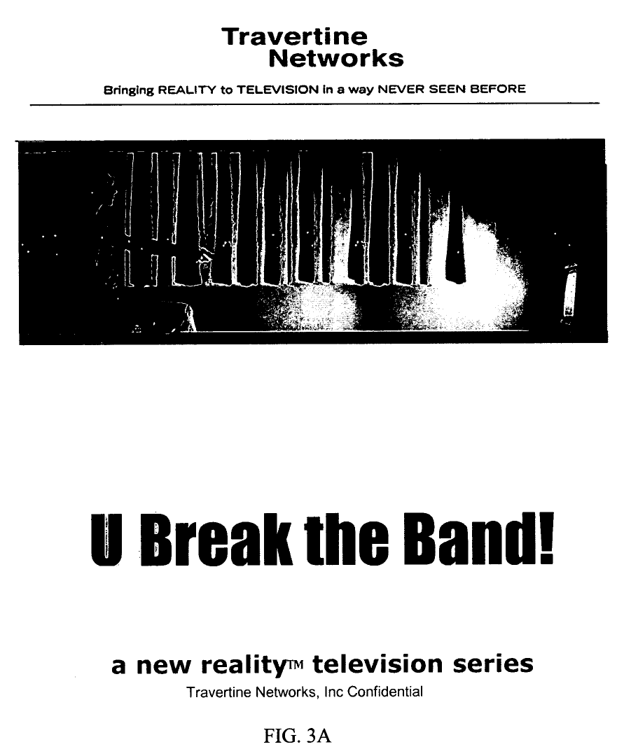

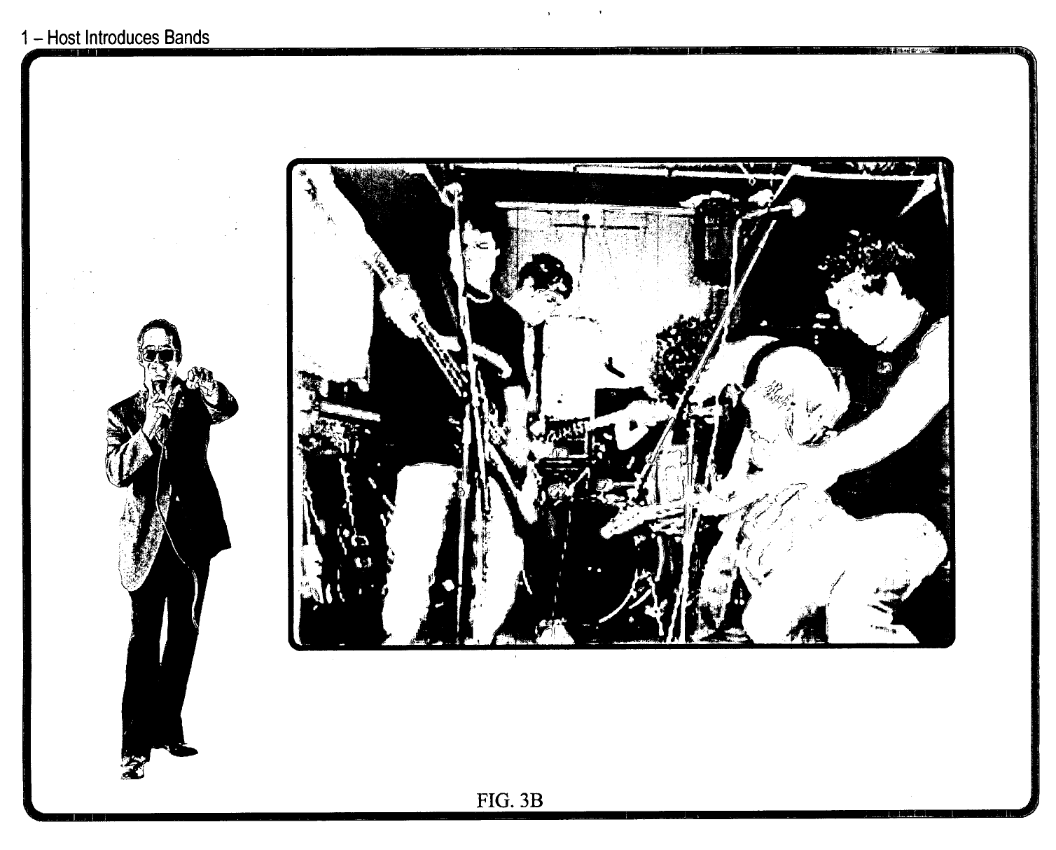

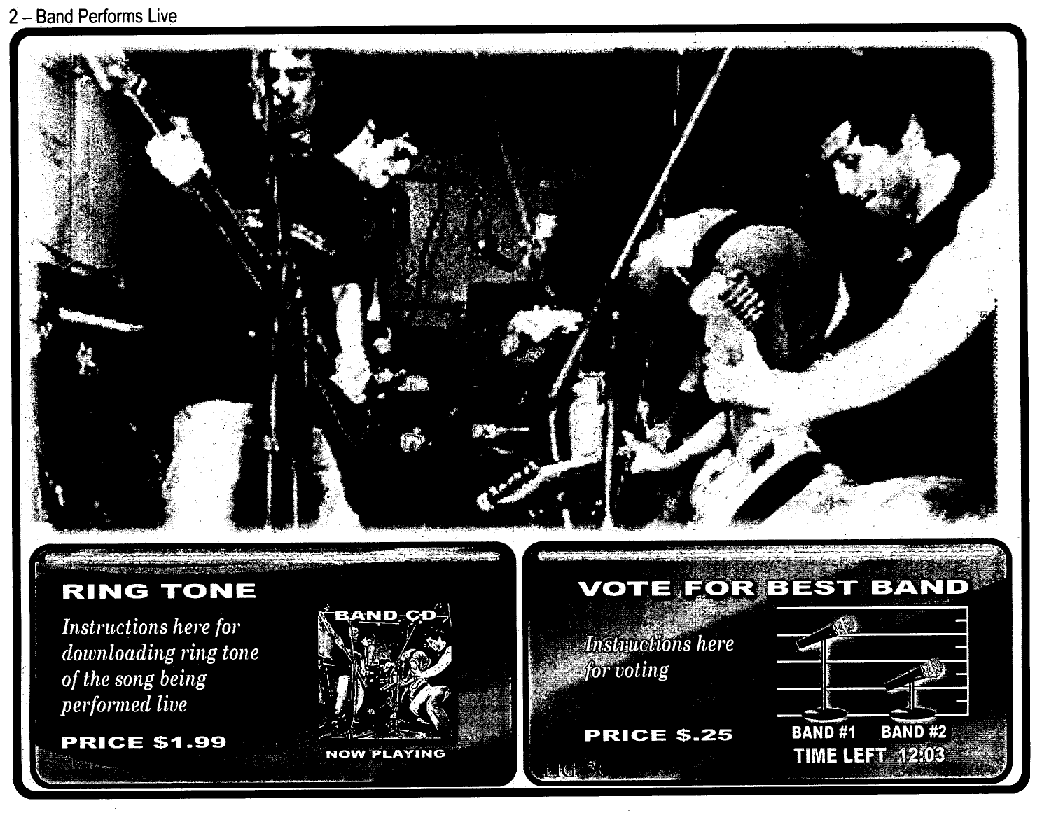

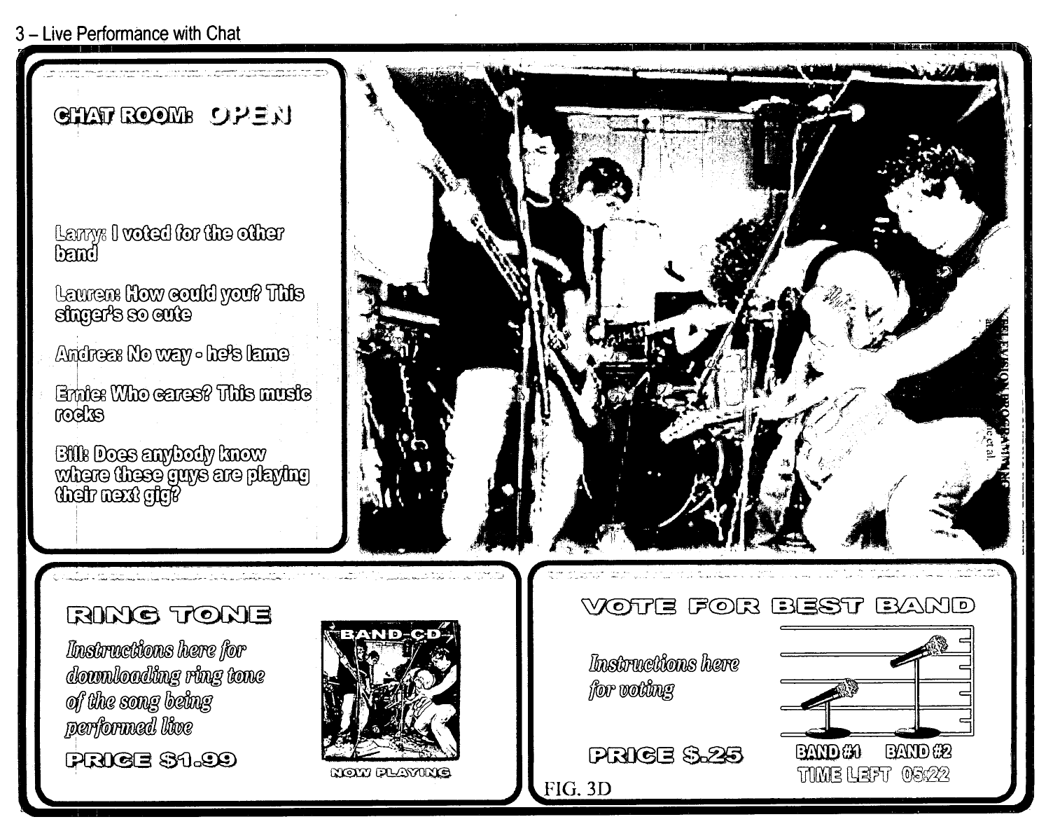

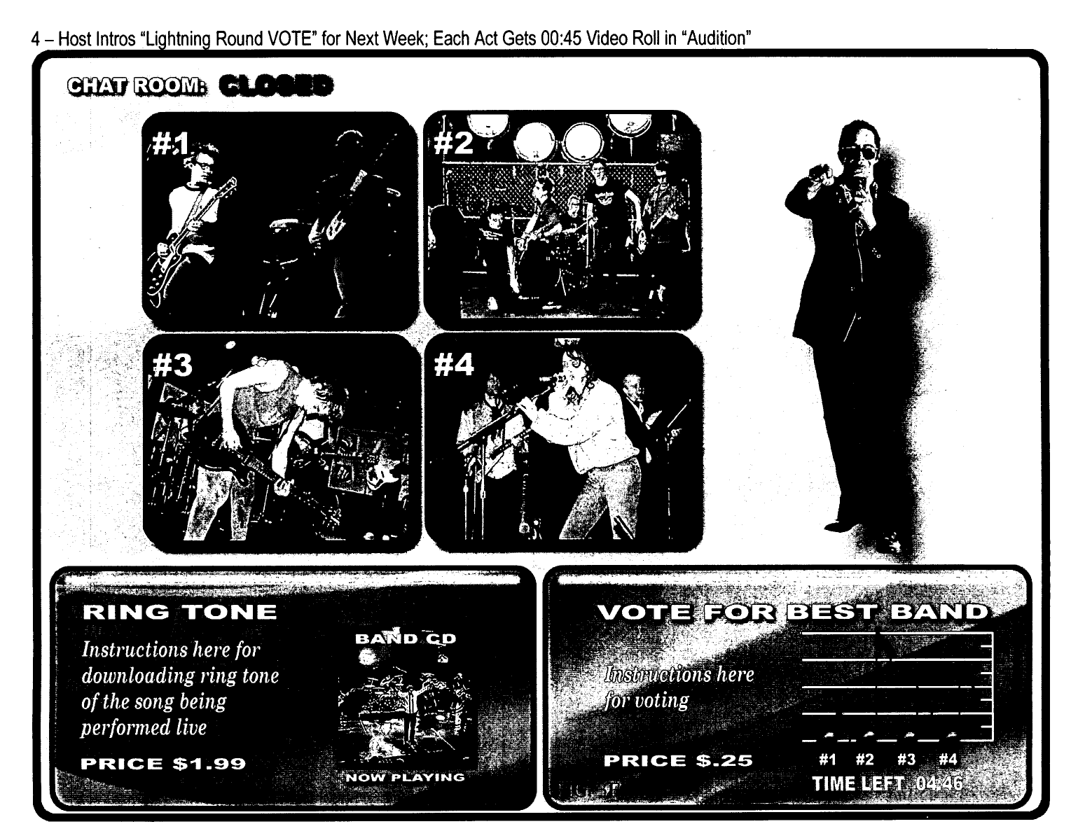

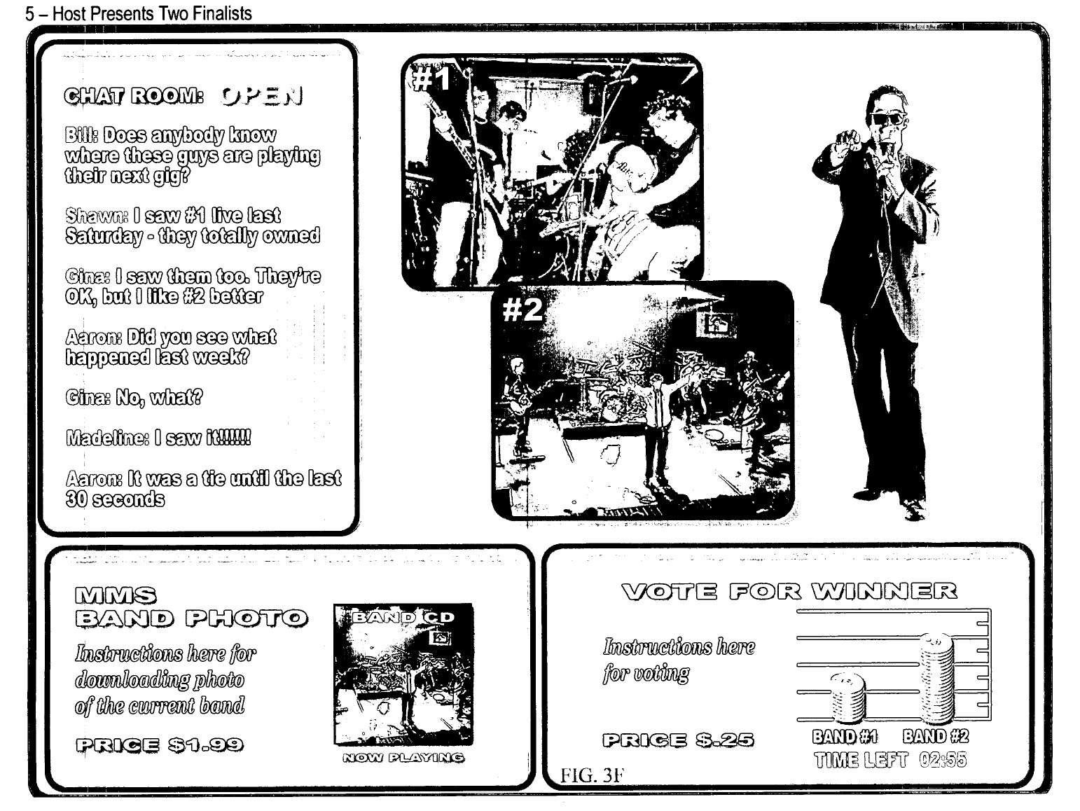

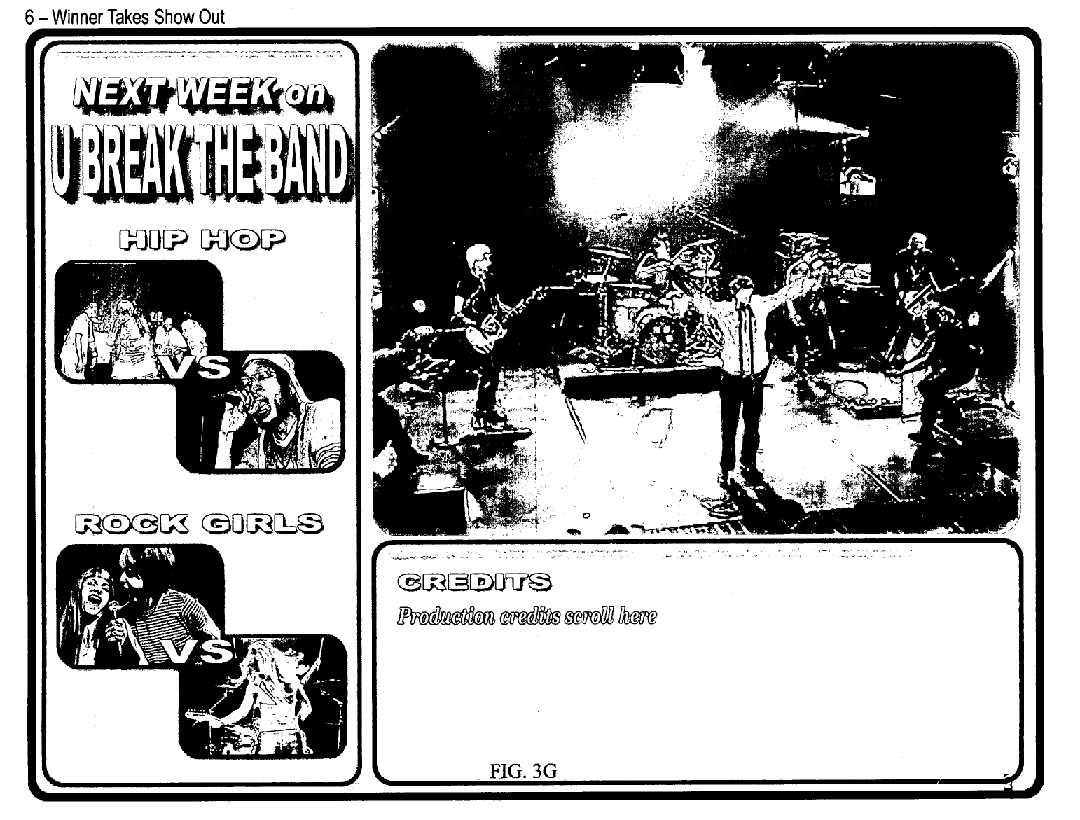

FIGS. 3A-3G are exemplary displays of one of the preferred embodiment of the invention. One preferred embodiment of the invention is a reality television show called “Break the Band.” (See FIGS. 3A-3G and Travertine Networks: Bringing Reality to Television in a Way Never Seen Before—U Break the Band!; and “U Break the Band,”, incorporated by reference in provisional application 60/571,413.) This embodiment is a reality program, wherein bands play original music, and the television audience participates in the show in various ways. In one embodiment, the audience can vote via text message sent from a mobile phone on which band will win that episode and move on to the next round. In another embodiment, the audience can chat with other audience members via text messaging, and such conversations are displayed in a separate box on the screen during the show. In yet another embodiment, the audience members can download songs played by the bands as ring tones on their mobile phones.

In FIGS. 3A-3G, the storyboards illustrate how the screen real estate is divided so that several things are happening simultaneously. As one example, a musical group performs in one part of the screen. Another section features live texted chat from the viewers. The bottom portion of the screen offers viewers a chance to immediately download a ring tone of the song they are hearing directly to their cell phone. A different section graphically displays the ever-changing tally of votes to select a winner as they are being texted live into the show.

Still another embodiment enables advertisers to sponsor live voting updates during commercial breaks, such that the advertisement becomes part of the show. A further embodiment allows advertisers to directly contact audience members during the week with advertiser-sponsored cell phone alerts.

The combination of the popular SMS technology with television programming to create truly interactive television will certainly revolutionize television programming for viewers and advertisers alike with its mass appeal.

A detailed explanation of the reality television series “U BREAK THE BAND” is described herein.

“U BREAK THE BAND” is a television series that turns the spotlight on bands who believe in the American Dream.

Using the same principle that drives ‘Survivor’, ‘American Idol’, or ‘The Apprentice’, “U BREAK THE BAND” offers the opportunity to everyone who wants it; rewards hard work and ability; and ultimately tells a captivating story about winners.

But “U BREAK THE BAND” is totally unique. For the first time on television viewers are making decisions about the show they're watching—live . . . from who's on it . . . to who wins it. Each week the hour-long show originates live from a music club in Hollywood.

Using live, inter-active, cell phone text messaging, viewers at home are in control as they give extraordinary musicians a stage to strut their stuff . . . pop, urban, rock, or country/blues . . . and only the viewing audience can make their dreams come true.

Each week features two types of music. Two groups playing their original material compete against each other in each of two categories for the right to go head to head with the other winner and advance to the finals of the series.

During the hour there are also two lightning rounds in which our Host introduces short video roll-ins of four groups who are eligible for the categories in next week's show. Using the power of their cell phones, the audience selects which two groups from each lightning round they want to see compete live the next week.

There's no record label deciding who gets promoted . . . or radio stations defining the play list . . . if the fans say you're worthy—you are.

In a 13 week series, the first 10 weeks produce individual winners, five each competing in weeks 11 and 12, with those two winners meeting in the final of week 13.

Cash prizes, MP3 downloads of their music, a national distribution deal, and fame bring the winning groups the rewards they deserve. Only one group will win the cash prize and fame that goes with being the ultimate winner at the end of the series . . . but along the way viewers at home who love the music will have had the chance to be part of the ‘U’ in . . . “U BREAK THE BAND”.

But the big picture is that along the way viewers at home who love the music will have had the chance to be part of the ‘U’ in . . . “U BREAK THE BAND”.

“U BREAK THE BAND” is ‘lean forward’ television, designed for the young demographic that wants to be actively involved in their media.

It's also interesting to note that the series has a much more valuable life in re-run than nearly all reality shows. With a minor edit of the line cut, viewers will still be able to play with the show by downloading ring tones or chatting live, on-screen, even though the show they are watching is taped. Every live, interactive element from the original show will still be available in a re-broadcast, except voting.

Travertine is assembling a national network of industry experts and resources to ensure that we cast the show with the best undiscovered, unsigned talent by combining the expertise of:
1) Music industry agents and managers working to place unsigned acts.
2) Internet based web sites that help distribute and promote music from independent musicians such as umn.com (“unsignedmusicians.com”) that offer any band the opportunity to sign up and go through an evaluation by their peers, a process that produces a top artist list in a variety of musical categories.
3) Editors from the leading industry magazine, Music Connection, and other regional weeklies that cover the music scene across the country.
4) Booking agents and managers from clubs in the major urban areas that feature bands and competitions that bring out the fans. In future seasons, we anticipate traveling the early rounds of the series to a selection of these clubs for live shows.

All of these resources will submit band recommendations to be reviewed by “U BREAK THE BAND”'s in-house review board of music professionals. This review board includes Grammy winning producers and former A&R executives with major labels but will lean heavily toward famous musicians. From Beck to Bonnie Raitt, they have traveled the road our contestants are dreaming about . . . and a number of these musical household names have also expressed interest in being a co-host of the show for a week.

The review board selects the top bands to compete in each week's lightning rounds. The viewing audience will then decide—live—the show they want to see.

The target market for “U BREAK THE BAND” is enormous and highly targetable. We are working with the top Internet sites serving the independent music artists, representing nearly 250,000 registered bands and over 1 million dedicated fans who subscribe to these sites.

Apple's iTunes Music Store has over 100,000 songs from independent artists (20% of their song inventory) and its 3.5+ million ipod and Windows users are downloading 2.5 million songs per week.

The cross promotions Travertine is putting in place to target this market will virtually guarantee a huge audience.

Add to the mix is the fact that the 18-34 yr old demographic targeted for this series is also the generation that has totally embraced text messaging. They are the largest, fastest growing and most active market segment for test messaging with nearly 75% texting on a daily basis.

Viewers don't have to participate in the premium text messaging of the show to have a lot of fun but all the voters are automatically included in a weekly sweepstakes drawing to win a trip for two to the finals. In Week 13, at least twenty-four lucky fans will be behind the scenes with the stars they've helped create.

The show is both surf and Tivo resistant in part because it's live. But advertisers can go further . . . even sponsoring live voting updates during a commercial break; in effect, the ad becomes part of the show. Cell phone alerts sponsored during the week offer advertisers a chance to directly connect to the audience they want. There is no way to calculate either the word of mouth effect or the brand association with a hip series as . . .

“U BREAK THE BAND” becomes appointment television for millions in the young demographic advertisers covet.

The descriptions provided herein are exemplary of preferred embodiments only. The inventors do not hereby disclaim any modifications or variations of these embodiments which may be made by those skilled in the art without departing from the true spirit and scope of the invention.

1. A method for providing interactive television programming, comprising the steps of:
routing Short Messaging System (SMS) data from a text-enabled wireless device, through a wireless carrier, to a server;
compiling said SMS data and converting to a graphical format; and
adding said SMS data in graphical format to a broadcast television signal for display on a television program.

2. The method of claim 1, further comprising the step of:
allowing a television viewer to participate in said television program by sending text messages from said text-enabled wireless device.
